(19) United States
(12) Patent Application Publication
(10) Pub. No.: US 2008/0244037 A1
(43) Pub. Date: Oct. 2, 2008

(54) Information distribution system, information processing apparatus and method, and information distribution apparatus and method

(75) Inventor: Hiroshi Okuda, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/075,321

(22) Filed: Mar. 11, 2008

(30) Foreign Application Priority Data
Mar. 30, 2007 (JP) P2007-094010

(51) Int. Cl. G06F 15/16

(52) U.S. Cl. 709/217

(57) ABSTRACT

Disclosed herein is an information processing system, including: a plurality of information processing apparatus configured to issue a request for transmission of a content; and an information distribution apparatus configured to distribute the content to the information processing apparatus; each of the information processing apparatus having an inputting control section, and a transmission control section; the information distribution apparatus having a distribution reservation information registration section, and a scheduling section.

### CROSS REFERENCES TO RELATED APPLICATIONS

The present invention contains subject matter related to Japanese Patent Application JP 2007-094010 filed in the Japan Patent Office on Mar. 30, 2007, the entire contents of which being incorporated herein by reference.

### BACKGROUND OF THE INVENTION

1. Field of the Invention

This invention relates to an information distribution system, an information processing apparatus and method, and an information distribution apparatus and method, and more particularly to an information distribution system, an information processing apparatus and method, and an information distribution apparatus and method by which a content is distributed to a user by time at which the user wants to enjoy the content.

2. Description of the Related Art

In the past, when a server distributes contents, the server either uses best efforts to distribute the contents or distributes the contents in a predetermined band limitation. In this instance, when a user wants to enjoy, the user would select a content or program and issue an instruction to start downloading. However, the user may not start enjoyment of the program before the downloading is completed.

On the other hand, in the case of streaming reproduction, when the user wants to enjoy, if the user selects a content or program, then the user can start enjoyment of the program immediately. However, when a content of high picture quality is to be enjoyed, a sufficiently wide band for transmission is requisite, and if the bandwidth is insufficient, then reproduction of the content does not progress smoothly or is interrupted.

Therefore, an information processing method has been proposed wherein a request for one of a plurality of data divided from data of one content is transmitted from each of a plurality of communication sections of the client side, and transmission of a plurality of data to be downloaded is allocated to a plurality of servers. The information processing method described is disclosed, for example, in Japanese Patent Laid-Open No. 2006-244054.

Also a method has been proposed wherein, for example, a server records programs reserved through the Internet and distributes the recorded programs to the client side in response to a downloading request.

### SUMMARY OF THE INVENTION

However, with the methods described above, downloading of a content is not necessarily completed by a point of time at which a user wants to enjoy the content.

Therefore, it is demanded to distribute a content efficiently by a point of time at which a user wants to enjoy the content.

According to an embodiment of the present invention, there is provided an information processing system including a plurality of information processing apparatus configured to issue a request for transmission of a content, and an information distribution apparatus configured to distribute the content to the information processing apparatus, each of the information processing apparatus including inputting control means for controlling inputting of viewing starting scheduled time at which a user is to start enjoyment of the content whose transmission is requested, and transmission control means for controlling transmission of information indicative of the inputted viewing starting scheduled time to the information distribution apparatus, the information distribution apparatus including distribution reservation information registration means for registering distribution reservation information within which information indicative of viewing starting scheduled time transmitted from the plural information processing apparatus and content information representative of contents whose transmission is requested individually from the plural information processing apparatus are associated with each other, and scheduling means for calculating, based on the distribution reservation information, for each of the information processing apparatus, distribution starting scheduled time which is earlier than the viewing starting scheduled time and at which distribution of a content is to be started and distribution ending scheduled time at which the distribution of the content is to be ended thereby to carry out scheduling of distribution of the contents.

In the information processing system, the inputting control means of each of the information processing apparatus controls inputting of viewing starting scheduled time at which a user is to start enjoyment of a content whose transmission is requested. Then, the transmission control means controls transmission of information indicative of the inputted viewing starting scheduled time to the information distribution apparatus. The distribution reservation information registration means of the information distribution apparatus registers distribution reservation information within which information indicative of viewing starting scheduled time transmitted from the plural information processing apparatus and content information representative of contents whose transmission is requested individually from the plural information processing apparatus are associated with each other. Then, the scheduling means calculates, based on the distribution reservation information, for each of the information processing apparatus, distribution starting scheduled time which is earlier than the viewing starting scheduled time and at which distribution of a content is to be started and distribution ending scheduled time at which the distribution of the content is to be ended thereby to carry out scheduling of distribution of the contents.

With the information processing system, a content can be distributed. Particularly, a content can be distributed efficiently by time at which the user wants to enjoy the content.

According to another embodiment of the present invention, there is provided an information processing apparatus which issues a request for transmission of a content to an information distribution apparatus, including inputting control means for controlling inputting of viewing starting scheduled time at which a user is to start enjoyment of the content whose transmission is requested, and transmission control means for controlling transmission of information indicative of the inputted viewing starting scheduled time to the information distribution apparatus.

The information processing apparatus may further include reception control means for controlling reception of a scheduling completion notification transmitted from the information distribution apparatus and indicating that distribution of the content is scheduled as a result of calculation of distribution starting scheduled time which is earlier than the viewing starting scheduled time and at which distribution of the content is to be started and distribution ending scheduled time at which the distribution of the content is to be ended, and power supply control means for controlling the power supply based on the distribution starting scheduled time included in the scheduling completion notification so that the power supply is turned on by the distribution starting scheduled time.

The reception control means may control reception of the content whose transmission is requested and whose distribution is scheduled by the information distribution apparatus.

According to a third embodiment of the present invention, there is provided an information processing method for an information processing apparatus which issues a request for transmission of a content to an information distribution apparatus, including the steps of controlling inputting of viewing starting scheduled time at which a user is to start enjoyment of the content whose transmission is requested, and controlling transmission of information indicative of the inputted viewing starting scheduled time to the information distribution apparatus.

In the information processing apparatus and the information processing method, inputting of viewing starting scheduled time at which a user is to start enjoyment of the content whose transmission is requested is controlled. Then, transmission of information indicative of the inputted viewing starting scheduled time to the information distribution apparatus is controlled.

With the information processing apparatus and the information processing method, transmission of a content can be requested. Particularly, it is possible to issue a request to transmit a content efficiently by time at which the user wants to enjoy the content.

According to a fourth embodiment of the present invention, there is provided an information distribution apparatus which distributes a content to an information processing apparatus, including distribution reservation information registration means for registering distribution reservation information wherein information transmitted from a plurality of information processing apparatus and indicative of viewing starting scheduled time at which a user of each of the information processing apparatus is to start enjoyment of a content whose transmission is requested from the information processing apparatus and content information transmitted from each of the plural information processing apparatus and indicative of the content whose transmission is requested from the information processing apparatus are associated with each other, and scheduling means for calculating, based on the distribution reservation information, for each of the information processing apparatus, distribution starting scheduled time which is earlier than the viewing starting scheduled time and at which distribution of a content is to be started and distribution ending scheduled time at which the distribution of the content is to be ended thereby to carry out scheduling of distribution of the contents.

The information distribution apparatus may be configured such that the distribution reservation information registration means registers the distribution reservation information wherein information indicative of viewing starting scheduled time transmitted from the plural information processing apparatus and information indicative of the amount of data of the contents whose transmission is requested individually from the plural information processing apparatus, and the scheduling means calculates, for each of the information processing apparatus, the distribution starting scheduled time and the distribution ending scheduled time from the viewing starting scheduled time, the data amount of the content, and a distribution capacity representative of the amount of data which can be distributed to the information processing apparatus thereby to carry out the scheduling of distribution of the contents.

The information distribution apparatus may further include viewing reservation settable time calculation means for calculating, for each of the information processing apparatus, from the present point of time and a distribution time period requisite to distribute the content whose transmission is requested by the user and obtained from the amount of data of the content and a distribution capacity representative of the amount of data which can be distributed to the information processing apparatus, viewing scheduled settable time which is time which is most proximate to the viewing starting scheduled time of the content whose transmission is requested by the user and which is settable as the viewing starting scheduled time, and validity decision means for comparing the viewing reservation settable time and the viewing starting scheduled time with each other to decide whether or not the request for transmission of the content from the information processing apparatus is valid.

In this instance, the validity decision means may decide whether or not the request for transmission of the content is valid based on information representative of whether credit settlement of a credit card owned by the user is permissible or information representative of a free capacity of a recording medium of the information processing apparatus.

The information distribution apparatus may further include distribution schedule information registration means for registering distribution schedule information within which the content information of the contents whose transmission is requested by the users and the distribution starting scheduled time and the distribution ending scheduled time are associated with each other, the scheduling means carrying out the scheduling such that, where the amount of data to be distributed to the information processing apparatus has some margin, distribution of that one of the contents with regard to which the distribution starting scheduled time of the distribution schedule information is later than the present point of time but is nearest to the present point of time is started at the present point of time of the content, represented by the content information, in the distribution schedule information.

The information distribution apparatus may be configured such that the content information includes charging information representative of an amount of money to be claimed to the user in response to distribution of the content and information indicative of a card number representative of the number of a credit card owned by the user and a term of validity of the credit card and used to carry out credit settlement of the amount of money indicated by the charging information, the information distribution apparatus further including charging processing means for carrying out a charging process based on the charging information and the information indicative of the card number representative of the number of the credit card and the term of validity of the credit card.

In this instance, the information distribution apparatus may be configured such that the charging processing means changes the amount of money in response to the length of an interval of time between reservation time at which the information representative of the viewing starting scheduled time is transmitted from the information processing apparatus and the viewing starting scheduled time to carry out the charging process.

According to a fifth embodiment of the present invention, there is provided an information distribution method for an information distribution apparatus which distributes a content to an information processing apparatus, including the steps of registering distribution reservation information wherein information transmitted from a plurality of information processing apparatus and indicative of viewing starting scheduled time at which a user of each of the information processing apparatus is to start enjoyment of a content whose transmission is requested from the information processing apparatus and content information transmitted from each of the plural information processing apparatus and indicative of the content whose transmission is requested from the information processing apparatus are associated with each other, and calculating, based on the distribution reservation information, for each of the information processing apparatus, distribution starting scheduled time which is earlier than the viewing starting scheduled time and at which distribution of a content is to be started and distribution ending scheduled time at which the distribution of the content is to be ended thereby to carry out scheduling of distribution of the contents.

In the information distribution apparatus and the information distribution method, distribution reservation information is registered wherein information transmitted from a plurality of information processing apparatus and indicative of viewing starting scheduled time at which a user of each of the information processing apparatus is to start enjoyment of a content whose transmission is requested from the information processing apparatus and content information transmitted from each of the plural information processing apparatus and indicative of the content whose transmission is requested from the information processing apparatus are associated with each other. Then, based on the distribution reservation information, for each of the information processing apparatus, distribution starting scheduled time which is earlier than the viewing starting scheduled time and at which distribution of a content is to be started and distribution ending scheduled time at which the distribution of the content is to be ended are calculated thereby to carry out scheduling of distribution of the contents.

With the information distribution apparatus and the information distribution method, a content can be distributed. Particularly, a content can be distributed efficiently by time at which the user wants to enjoy the content.

### BRIEF DESCRIPTION OF THE DRAWINGS

FIG. 1 is a block diagram showing an example of a configuration of a content distribution system to which the present invention is applied;

FIG. 2 is a block diagram showing an example of a hardware configuration of a content server shown in FIG. 1;

FIG. 3 is a block diagram showing a functional configuration implemented by a CPU of the content server of FIG. 2;

FIG. 4 is a view illustrating an example of user information stored in a user authentication database shown in FIG. 3;

FIG. 5 is a view illustrating an example of content information stored in a content database shown in FIG. 3;

FIG. 6 is a view illustrating an example of distribution reservation information stored in a distribution reservation database shown in FIG. 3;

FIG. 7 is a view illustrating an example of distribution completion information stored in a distribution completion database shown in FIG. 3;

FIG. 8 is a view illustrating an example of distribution schedule information stored in a distribution schedule database shown in FIG. 3;

FIG. 9 is a block diagram showing an example of hardware configuration of a client terminal apparatus shown in FIG. 1;

FIG. 10 is a block diagram showing a functional configuration implemented by a CPU of the client terminal apparatus of FIG. 9;

FIG. 11 is a schematic view showing a user registration screen image of the client terminal of FIG. 9;

FIG. 12 is a schematic view showing a log-in screen image of the client terminal of FIG. 9;

FIG. 13 is a schematic view showing a user registration change screen image of the client terminal of FIG. 9;

FIG. 14 is a schematic view showing a user registration deletion screen image of the client terminal of FIG. 9;

FIG. 15 is a schematic view showing a content search screen image of the client terminal of FIG. 9;

FIG. 16 is a schematic view showing a download reservation screen image of the client terminal of FIG. 9;

FIG. 17 is a schematic view showing a download reservation list screen image of the client terminal of FIG. 9;

FIG. 18 is a schematic view showing a title list screen image of the client terminal of FIG. 9;

FIG. 19 is a flow chart illustrating a user information registration process executed in the content distribution system of FIG. 1;

FIG. 20 is a flow chart illustrating a content downloading reservation process executed in the content distribution system of FIG. 1; and

FIG. 21 is a flow chart illustrating a re-scheduling process executed by the content server shown in FIG. 1.

### DETAILED DESCRIPTION OF THE PREFERRED EMBODIMENT

Before a preferred embodiment of the present invention is described in detail, a corresponding relationship between several features recited in the accompanying claims and particular elements of the preferred embodiment described below is described. The description, however, is merely for the confirmation that the particular elements which support the invention as recited in the claims are disclosed in the description of the embodiment of the present invention. Accordingly, even if some particular element which is recited in description of the embodiment is not recited as one of the features in the following description, this does not signify that the particular element does not correspond to the feature. On the contrary, even if some particular element is recited as an element corresponding to one of the features, this does not signify that the element does not correspond to any other feature than the element.

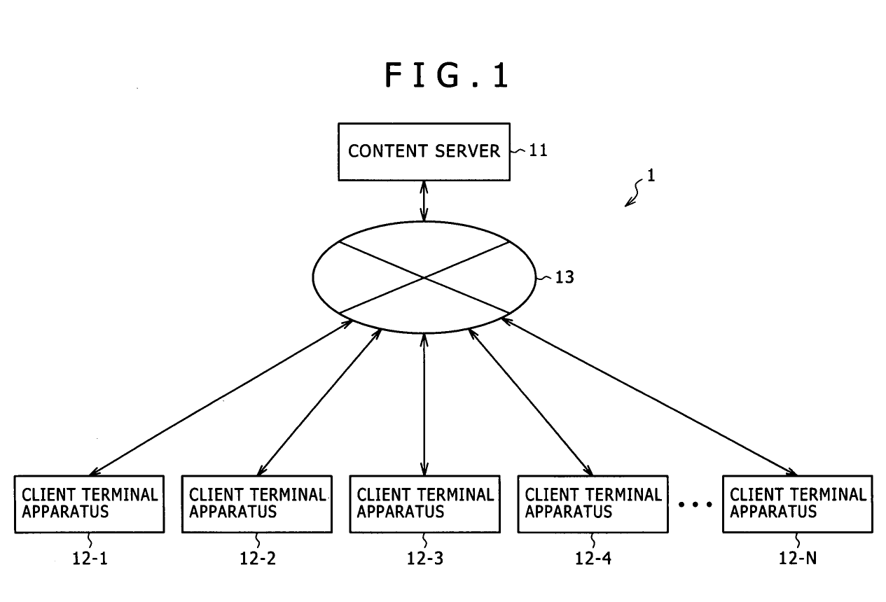

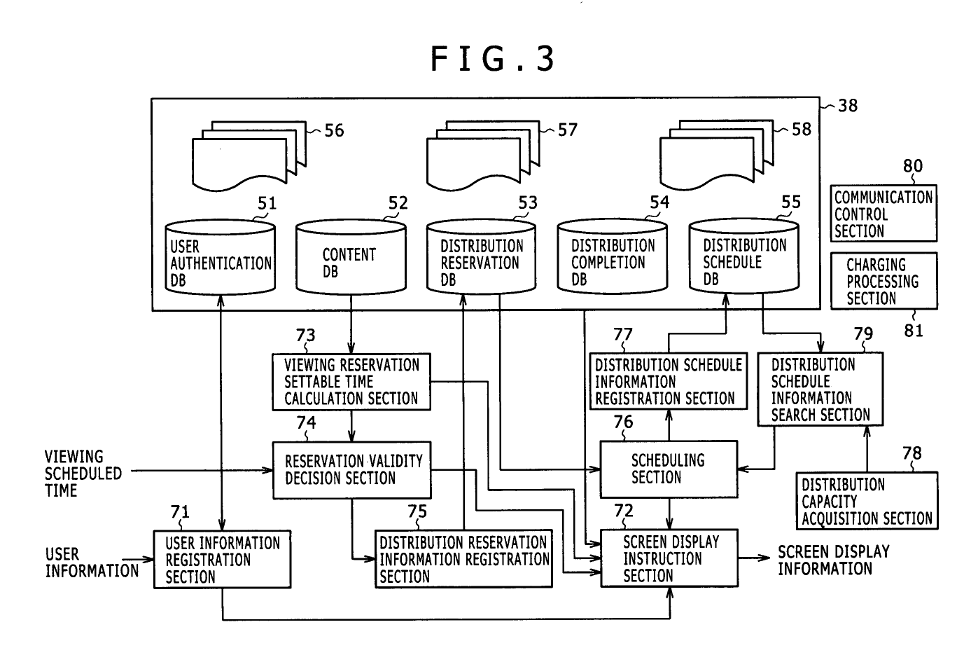

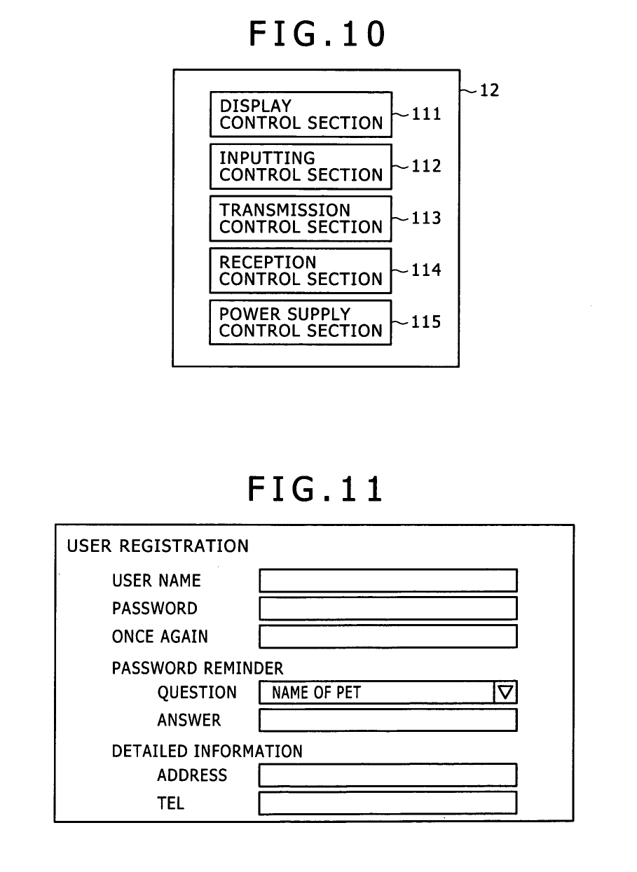

According to an embodiment of the present invention, there is provided an information processing system including a plurality of information processing apparatus (for example, client terminal apparatus 12 shown in FIG. 1) configured to issue a request for transmission of a content, and an information distribution apparatus (for example, a content server 11 shown in FIG. 1) configured to distribute the content to the information processing apparatus, each of the information processing apparatus including an inputting control section (for example, an inputting control section 112 shown in FIG. 10) configured to control inputting of viewing starting scheduled time at which a user is to start enjoyment of the content whose transmission is requested, and a transmission control section (for example, a transmission control section 113 shown in FIG. 10) configured to control transmission of information indicative of the inputted viewing starting scheduled time to the information distribution apparatus, the information distribution apparatus including a distribution reservation information registration section (for example, a distribution reservation information registration section 75 shown in FIG. 3) configured to register distribution reservation information within which information indicative of viewing starting scheduled time transmitted from the plural information processing apparatus and content information representative of contents whose transmission is requested individually from the plural information processing apparatus are associated with each other, and a scheduling section (for example, a scheduling section 76 shown in FIG. 3) configured to calculate, based on the distribution reservation information, for each of the information processing apparatus, distribution starting scheduled time which is earlier than the viewing starting scheduled time and at which distribution of a content is to be started and distribution ending scheduled time at which the distribution of the content is to be ended thereby to carry out scheduling of distribution of the contents.

According to another embodiment of the present invention, there is provided an information processing apparatus which issues a request for transmission of a content to an information distribution apparatus, including an inputting control section (for example, an inputting control section 112 shown in FIG. 10) configured to control inputting of viewing starting scheduled time at which a user is to start enjoyment of the content whose transmission is requested, and a transmission control section (for example, a transmission control section 113 shown in FIG. 10) configured to control transmission of information indicative of the inputted viewing starting scheduled time to the information distribution apparatus.

The information processing apparatus may further include a reception control section (for example, a reception control section 114 shown in FIG. 10) configured to control reception of a scheduling completion notification transmitted from the information distribution apparatus and indicating that distribution of the content is scheduled as a result of calculation of distribution starting scheduled time which is earlier than the viewing starting scheduled time and at which distribution of the content is to be started and distribution ending scheduled time at which the distribution of the content is to be ended, and a power supply control section (for example, a power supply control section 115 shown in FIG. 10) configured to control the power supply based on the distribution starting scheduled time included in the scheduling completion notification so that the power supply is turned on by the distribution starting scheduled time.

The reception control section may control reception of the content whose transmission is requested and whose distribution is scheduled by the information distribution apparatus.

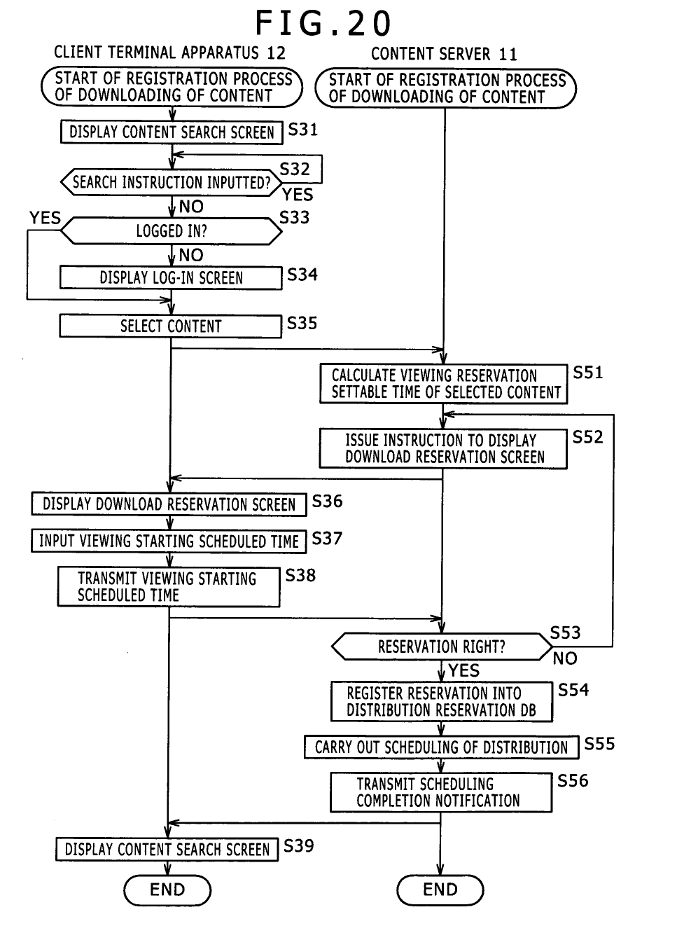

According to a third embodiment of the present invention, there is provided an information processing method for an information processing apparatus which issues a request for transmission of a content to an information distribution apparatus, including the steps of controlling inputting of viewing starting scheduled time at which a user is to start enjoyment of the content whose transmission is requested (for example, a step S37 illustrated in FIG. 20), and controlling transmission of information indicative of the inputted viewing starting scheduled time to the information distribution apparatus (for example, a step S8 illustrated in FIG. 20).

According to a fourth embodiment of the present invention, there is provided an information distribution apparatus which distributes a content to an information processing apparatus, including a distribution reservation information registration section (for example, a distribution reservation information registration section 75 shown in FIG. 3) configured to register distribution reservation information wherein information transmitted from a plurality of information processing apparatus and indicative of viewing starting scheduled time at which a user of each of the information processing apparatus is to start enjoyment of a content whose transmission is requested from the information processing apparatus and content information transmitted from each of the plural information processing apparatus and indicative of the content whose transmission is requested from the information processing apparatus are associated with each other, and a scheduling section (for example, a scheduling section 76 shown in FIG. 3) configured to calculate, based on the distribution reservation information, for each of the information processing apparatus, distribution starting scheduled time which is earlier than the viewing starting scheduled time and at which distribution of a content is to be started and distribution ending scheduled time at which the distribution of the content is to be ended thereby to carry out scheduling of distribution of the contents.

The information distribution apparatus may be configured such that the distribution reservation information registration section registers the distribution reservation information wherein information indicative of viewing starting scheduled time transmitted from the plural information processing apparatus and information indicative of the amount of data of the contents whose transmission is requested individually from the plural information processing apparatus (for example, a step S54 illustrated in FIG. 20), and the scheduling section calculates, for each of the information processing apparatus, the distribution starting scheduled time and the distribution ending scheduled time from the viewing starting scheduled time, the data amount of the content, and a distribution capacity representative of the amount of data which can be distributed to the information processing apparatus thereby to carry out the scheduling of distribution of the contents (for example, a step S55 illustrated in FIG. 20).

The information distribution apparatus may further include a viewing reservation settable time calculation section (for example, a viewing reservation settable time calculation section 73 shown in FIG. 3) configured to calculate, for each of the information processing apparatus, from the present point of time and a distribution time period requisite to distribute the content whose transmission is requested by the user and obtained from the amount of data of the content and a distribution capacity representative of the amount of data which can be distributed to the information processing apparatus, viewing scheduled settable time which is time which is most proximate to the viewing starting scheduled time of the content whose transmission is requested by the user and which is settable as the viewing starting scheduled time, and a validity decision section (for example, a reservation validity decision section 74 shown in FIG. 3) configured to compare the viewing reservation settable time and the viewing starting scheduled time with each other to decide whether or not the request for transmission of the content from the information processing apparatus is valid.

In this instance, the validity decision section may decide whether or not the request for transmission of the content is valid based on information representative of whether credit settlement of a credit card owned by the user is permissible or information representative of a free capacity of a recording medium of the information processing apparatus (for example, a step S53 illustrated in FIG. 20).

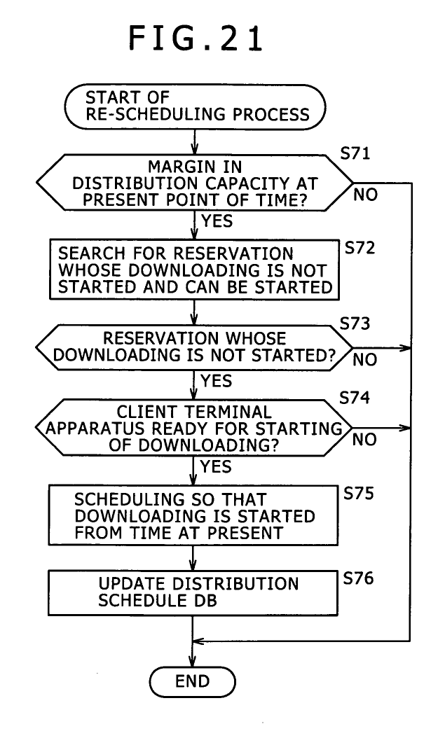

The information distribution apparatus may further include a distribution schedule information registration section (for example, a distribution schedule information registration section 77 shown in FIG. 3) configured to register distribution schedule information within which the content information of the contents whose transmission is requested by the users and the distribution starting scheduled time and the distribution ending scheduled time are associated with each other, the scheduling section carrying out the scheduling such that, where the amount of data to be distributed to the information processing apparatus has some margin, distribution of that one of the contents with regard to which the distribution starting scheduled time of the distribution schedule information is later than the present point of time but is nearest to the present point of time is started at the present point of time of the content, represented by the content information, in the distribution schedule information (for example, a step S75 illustrated in FIG. 21).

The information distribution apparatus may be configured such that the content information includes charging information representative of an amount of money to be claimed to the user in response to distribution of the content and information indicative of a card number representative of the number of a credit card owned by the user and a term of validity of the credit card and used to carry out credit settlement of the amount of money indicated by the charging information, the information distribution apparatus further including a charging processing section (for example, a charging processing section 81 shown in FIG. 3) configured to carry out a charging process based on the charging information and the information indicative of the card number representative of the number of the credit card and the term of validity of the credit card.

In this instance, the information distribution apparatus may be configured such that the charging processing section changes the amount of money in response to the length of an interval of time between reservation time at which the information representative of the viewing starting scheduled time is transmitted from the information processing apparatus and the viewing starting scheduled time to carry out the charging process.

According to a fifth embodiment of the present invention, there is provided an information distribution method for an information distribution apparatus which distributes a content to an information processing apparatus, including the steps of registering distribution reservation information wherein information transmitted from a plurality of information processing apparatus and indicative of viewing starting scheduled time at which a user of each of the information processing apparatus is to start enjoyment of a content whose transmission is requested from the information processing apparatus and content information transmitted from each of the plural information processing apparatus and indicative of the content whose transmission is requested from the information processing apparatus are associated with each other (for example, a step S54 illustrated in FIG. 20), and calculating, based on the distribution reservation information, for each of the information processing apparatus, distribution starting scheduled time which is earlier than the viewing starting scheduled time and at which distribution of a content is to be started and distribution ending scheduled time at which the distribution of the content is to be ended thereby to carry out scheduling of distribution of the contents (for example, a step S55 illustrated in FIG. 20).

In the following, a preferred embodiment of the present invention is described with reference to the accompanying drawings.

FIG. 1 shows an example of a configuration of a content distribution system 1 to which the present invention is applied.

Referring to FIG. 1, the content distribution system 1 shown includes a content server 11, a plurality of client terminal apparatus 12-1 to 12-N (N is a positive integer), and the Internet 13. In the content distribution system 1, the client terminal apparatus 12-1 to 12-N can issue a request to download a content to the content server 11, and the content server 11 distributes the requested content to the client terminal apparatus 12-1 to 12-N.

The content server 11 and the client terminal apparatus 12-1 to 12-N are connected to each other through the Internet 13. It is to be noted that, where there is no necessity to individually distinguish any of the client terminal apparatus 12-1 to 12-N, it is hereinafter referred to merely as client terminal apparatus 12. The client terminal apparatus 12 may be, for example, a hard disk drive (HDD) recorder.

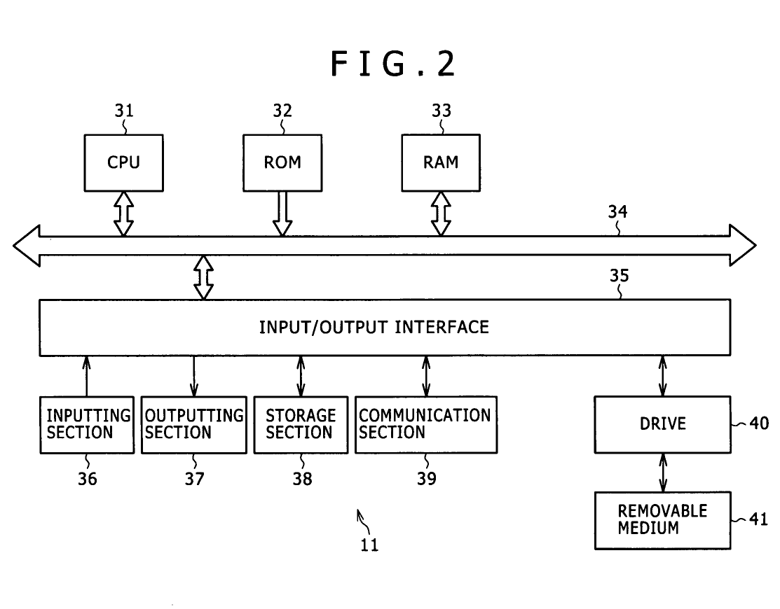

Referring now to FIG. 2, there is shown an example of a configuration of the content server 11. The content server 11 includes a central processing unit (CPU) 31 which executes various processes in accordance with a program stored in a read-only memory (ROM) 32 or a storage section 38. A program to be executed by the CPU 31, data and so forth are suitably stored into a random access memory (RAM 33). The CPU 31, ROM 32 and RAM 33 are connected to each other by a bus 34.

Also an input/output interface 35 is connected to the CPU 31 through the bus 34. An inputting section 36 including a keyboard, a mouse and a microphone and an outputting section 37 including a display unit and a speaker are connected to the input/output interface 35. The CPU 31 executes various processes in accordance with an instruction inputted thereto from the inputting section 36. The CPU 31 outputs a result of processing to the outputting section 37.

The storage section 38 is connected to the input/output interface 35 and is formed, for example, from a hard disk drive. The storage section 38 stores programs to be executed by the CPU 31 and data of contents to be distributed to the client terminal apparatus 12 and so forth. A communication section 39 communicates with an external apparatus such as a client terminal apparatus 12 through the Internet 13 and a network such as a local area network.

A program may otherwise be acquired through the communication section 39 and stored into the storage section 38.

A drive 40 is connected to the input/output interface 35 and drives, when a removable medium 41 such as a magnetic disk, an optical disk, a magneto-optical disk or a semiconductor memory is loaded therein, to acquire a program, a data and so forth recorded on the removable medium 41. The acquired program or data is transferred to and recorded into the storage section 38 as occasion demands.

FIG. 3 shows a functional configuration implemented by the CPU 31 of the content server 11 which executes a program.

Referring to FIG. 3, the content server 11 has various functions implemented by execution of a program by the CPU 31. In particular, the content server 11 includes a user information registration section 71, a screen display instruction section 72, a viewing reservation settable time calculation section 73, a reservation validity decision section 74, and a distribution reservation information registration section 75. The content server 11 further includes a scheduling section 76, a distribution schedule information registration section 77, a distribution capacity acquisition section 78, a distribution schedule information search section 79, a communication control section 80 and a charging processing section 81.

Meanwhile, a user authentication database (DB) 51, a content database (DB) 52, a distribution reservation database (DB) 53, a distribution completion database (DB) 54 and a distribution schedule database (DB) 55 are constructed in the storage section 38. The storage section 38 stores advertisement page data 56, user authentication page data 57 and content search/download page data 58.

The user authentication database 51 stores user information used for authentication of users. The user information includes a user ID (Identification) for specifying a user, a user name representative of the name of the user, a password with which the user is authenticated, a user registration date representative of the date on which the user was registered and a password reminder for reminding the user of the password when the password was forgotten, associated with each other. User information to be stored into the user authentication database 51 is generated when a user operates a client terminal apparatus 12 to carry out user registration, and is used for user authentication when the user tries to log in.

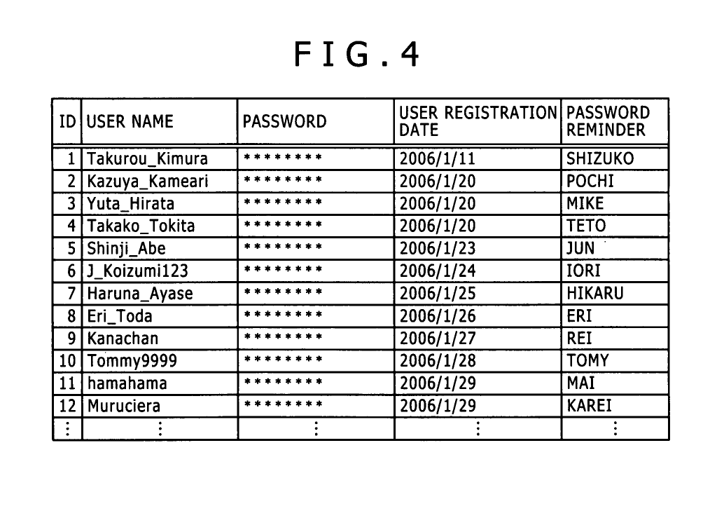

FIG. 4 illustrates an example of the user information stored in the user authentication database 51. Referring to FIG. 4, the user information of a user whose user name is “Takurou_Kumuran includes a user ID of “1,” a password of eight arbitrary alphanumeric characters, user registration data of “2006/1/11” representative of Jan. 11, 2006, and a password reminder of “Shizuko,” associated with each other, and is stored in the user authentication database 51. Meanwhile, the user information of a user whose user name is “Kazuya_Kameari” includes a user ID of “2,” a password of eight arbitrary alphanumeric characters, user registration data of “2006/1/20” representative of Jan. 20, 2006, and a password reminder of “Pochi,” associated with each other, and is stored in the user authentication database 51. Also user information of users whose user ID is “3” and so forth is stored in the user authentication database 51 similarly. It is to be noted that, while, in the user information illustrated in FIG. 4, the password of all users is indicated as “********,” actually the password of each user is represented by eight arbitrary alphanumerical characters determined by the user.

Referring back to FIG. 3, the content database 52 stores content information to be distributed from the content server 11 to the client terminal apparatus 12. The content information includes a content ID for specifying a content, a content name representative of the name of the content, a capacity representative of the amount of data of the content, a genre 1 representative of a large group into which the content is classified, a genre 2 representative of a small group into which the content classified in the genre 1 is further classified, charging information representative of an amount of money to be claimed to the user when the content is downloaded to a client terminal apparatus 12, detailed information representative of the substance of the content, and the name of a file of the content, associated with each other. The content information stored in the content database 52 is referred to when a user operates a client terminal apparatus 12 to search for or select a content.

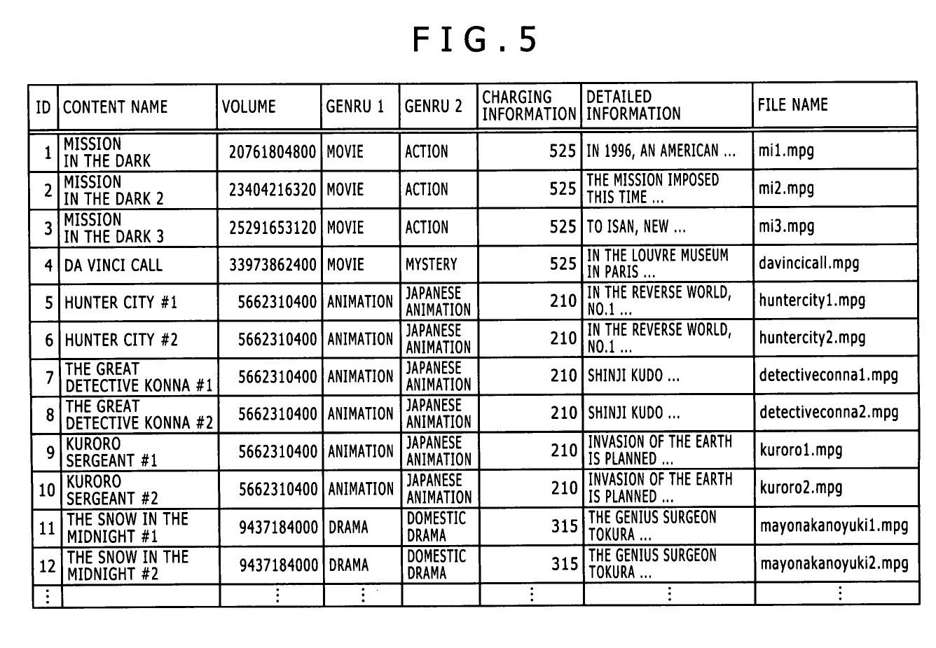

FIG. 5 illustrates an example of the content information stored in the content database 52. Referring to FIG. 5, the content information of a content whose content name is “Mission in the dark” includes a content ID of “1,” a capacity of “20761804800” representing that the amount of data of the content is 20,761,804,800 bytes, a genre 1 of “movie,” a genre 2 of “action,” charging information of “525” representing that the amount of money to be claimed to the user is 525 yen, detailed information of “In 1996, an American . . . ,” and a file name of “mi1.mpg,” associated with each other, and is stored in the content database 52. Meanwhile, the content information of a content whose content name is “Mission in the dark 2” includes a content ID of “2,” a capacity of “234042163200 representing that the data amount of the content is 23,404,216,320 bytes, a genre 1 of “movie,” a genre 2 of “action,” charging information of “525” representing that the amount of money to be claimed to the user is 525 yen, detailed information of “The mission imposed this time . . . ,” and a file name of “mi2.mpg,” associated with each other, and is stored in the content database 52. Also content information of contents whose content ID is “3” and so forth is stored in the content database 52 similarly.

Referring back to FIG. 3, the distribution reservation database 53 stores distribution reservation information representative of the substance of download reservations carried out by users. The distribution reservation information includes a distribution reservation ID for specifying a reservation of distribution of a content, a user ID for specifying a user who carried out processing for reservation of downloading of the content, a content ID for specifying the content for which the processing for reservation of downloading was carried out by the user indicated by the user ID, reservation time representative of date and time at which the reservation processing was carried out by the user, viewing starting scheduled time set by the reservation processing by the user and representative of the date and time at which the user wants to enjoy the content, charging information for the content specified by the content ID, a card number representative of the number of a credit card owned by the user for settling the credit of an amount of money indicated by the charging information, a term of validity of the credit card, and a distribution completion flag representative of whether or not distribution of the content to the user or client terminal apparatus 12 is completed, associated with each other. Distribution reservation information to be stored into the distribution reservation database 53 is generated when a user operates a client terminal apparatus 12 to reserve downloading of and purchase a content and is referred to in a content distribution scheduling process carried out by the content server 11.

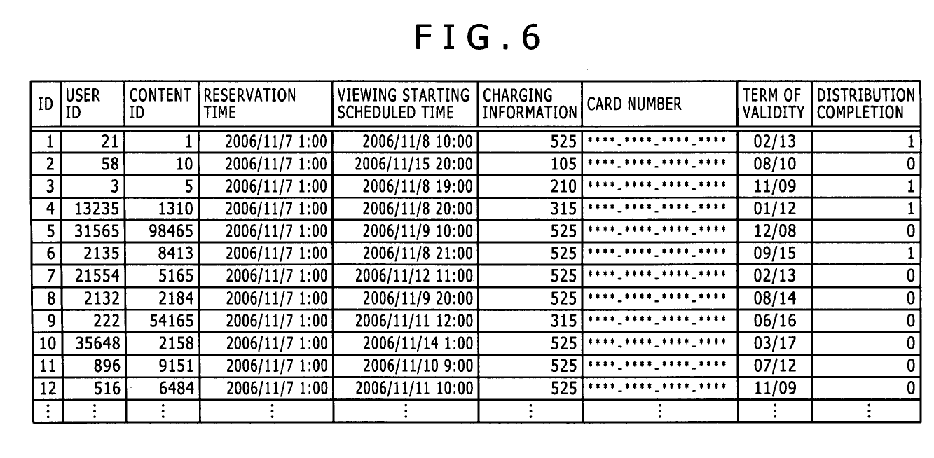

FIG. 6 illustrates an example of the distribution reservation information stored in the distribution reservation database 53. Referring to FIG. 6, the distribution reservation information of a reservation whose distribution reservation ID is “1” includes a user ID for the specification of a user indicated by “21,” a content ID for the specification of a content indicated by “1,” reservation time which is “2006/11/7 1:00” representative of 1:00 of Nov. 7, 2006, viewing starting scheduled time which is “2006/11/8 10:00” representative of 10:00 of Nov. 8, 2006, charging information which is “525” representing that the amount of money to be claimed to the user is 525 yen, a card number of a credit card, a term of validity which is “02/13” representative of February, 2013, and a distribution completion flag which is “1” representing that the distribution is completed, associated with each other, and is stored in the distribution reservation database 53. Meanwhile, the distribution reservation information of a reservation whose distribution reservation ID is “2” includes a user ID for the specification of a user indicated by “58,” a content ID for the specification of a content indicated by “10,” reservation time which is “2006/11/7 1:00” representative of 1:00 of Nov. 7, 2006, viewing starting scheduled time which is “2006/11/15 20:00” representative of 20:00 of Nov. 15, 2006, charging information which is “105” representing that the amount of money to be claimed to the user is 105 yen, a card number of a credit card, a term of validity which is “08/10” representative of August, 2010, and a distribution completion flag which is “0” representing that the distribution is not completed, associated with each other, and is stored in the distribution reservation database 53. Also information whose distribution reservation ID is “3” and so forth is stored in the distribution reservation database 53 similarly. It is so be noted that, while, in FIG. 6, the card number in all distribution reservation information is represented as “****_****_****_****,” actually the entire portion indicated by “*” (asterisk) is given as a number within 16 digits.

Referring back to FIG. 3, the distribution completion database 54 stores distribution completion information representing the substance of reservations with regard to which distribution of a content is completed from among downloading reservations carried out by users. The distribution completion information includes a distribution completion ID for specifying a reservation with regard to which distribution of a content is completed, a user ID for specifying a user who carried out a downloading reservation process of the content, a content ID for specifying the content for which the downloading reservation process of the content was carried out, reservation time representative of a date and time at which the reservation process was carried out by the user, viewing starting scheduled time set in the reservation process by the user and representative of a date and time at which the user wants to enjoy the content, charging information for the content specified by the content ID, a card number representative of the number of a credit card owned by the user for settling the credit of an amount of money indicated by the charging information, and a term of validity of the credit card, associated with each other. Distribution completion information to be stored into the distribution completion database 54 is generated from distribution reservation information whose distribution completion flag changes over to “1” in the distribution reservation database 53 when the content server 11 completes distribution of a content. Further, the distribution completion information is referred to upon calculation of a charge for or processing of a claim for a user who carried out an operation for downloading reservation.

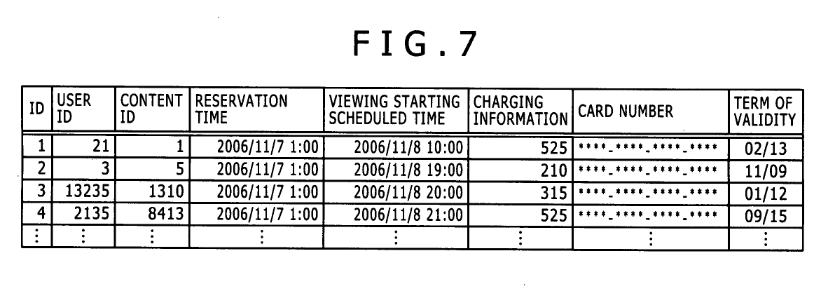

FIG. 7 illustrates an example of the distribution completion information stored in the distribution completion database 54. Referring to FIG. 7, the distribution completion information of a reservation whose distribution completion ID is “1” includes a user ID which specifies a user indicated by “21,” a content ID which specifies a content indicated by “1,” reservation time which is “2006/11/7 1:00” representative of 1:00 of Nov. 7, 2006, viewing starting scheduled time which is “2006/11/8 10:00” which represents 10:00 of Nov. 8, 2006, charging information which is “525” representing that the amount of money to be claimed to the user is 525 yen, a card number of a credit card, and a term of validity which is “02/13” representative of February, 2013, associated with each other, and is stored in the distribution completion database 54. Meanwhile, the distribution completion information of a reservation whose distribution completion ID is “2” includes a user ID which specifies a user indicated by “3,” a content ID which specifies a content indicated by “15,” reservation time which is “2006/11/7 1:00”, representative of 1:00 of Nov. 7, 2006, viewing starting scheduled time which is “2006/11/8 19:00” which represents 19:00 of Nov. 8, 2006, charging information which is “210” representing that the amount of money to be claimed to the user is 210 yen, a card number of a credit card, and a term of validity which is “11/09” representative of November, 2009, associated with each other, and is stored in the distribution completion database 54. Also information whose distribution completion ID is “3” and so forth is stored in the distribution completion database 54 similarly. It is so be noted that, while, in FIG. 7, the card number in all reservation information is represented as “****_****_****_****,” actually the entire portion indicated by “*” (asterisk) is given as a number within 16 digits. Further, as seen in FIG. 7, the distribution completion information stored in the distribution completion database 54 is composed of the distribution reservation information whose distribution completion flag is “1” representing completion of distribution in the distribution reservation database 53 shown in FIG. 6.

Referring back to FIG. 3, the distribution schedule database 55 stores distribution schedule information representative of time at which a content is to be downloaded in reservations of downloading made by users. The distribution schedule information includes a distribution schedule ID for specifying a reservation wherein downloading time of a content is determined, a user ID for specifying a user who carried out a downloading reservation process of the content, a content ID for specifying the content for which the downloading reservation process was carried out by the user indicated by the user ID, DL (download) starting scheduled time calculated in a scheduling process by the content server 11 and representative of time at which distribution of the content to a client terminal apparatus 12 is to be started, DL ending scheduled time calculated in the scheduling process by the content server 11 and representative of time at which the distribution of the content to the client terminal apparatus 12 is to be completed, charging information of the content specified by the content ID, a card number representative of the number of a credit card owned by the user for settling the credit of an amount of money indicated by the charging information, a term of validity of the credit card, and a distribution completion flag representative of whether or not downloading or distribution of the content to the user or client terminal apparatus 12 is completed, associated with each other. Distribution scheduled information to be stored into the distribution schedule database 55 is generated based on the distribution reservation information of the distribution reservation database 53 when a user operates a client terminal apparatus 12 to reserve downloading of and purchase the content, and is updated in the content distribution scheduling process carried out by the content server 11.

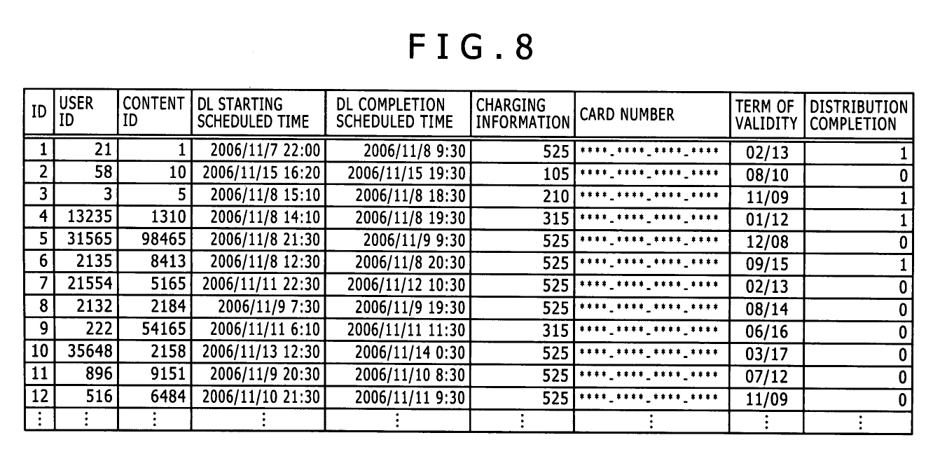

FIG. 8 illustrates an example of the distribution schedule information stored in the distribution schedule database 55. Referring to FIG. 8, the distribution schedule information of a reservation whose distribution schedule ID is “1” includes a user ID which specifies a user indicated by “21,” a content ID which specifies a content indicated by “1,” DL starting scheduled time which is “2006/11/7 22:00” representative of 22:00 of Nov. 7, 2006, DL completion scheduled time which is “2006/11/8 9:30” representative of 9:30 of Nov. 8, 2006, charging information which is “525” representing that the amount of money to be claimed to the user is 525 yen, a card number of a credit card, a term of validity which is “02/13” representative of February, 2013, and a distribution completion flag which is “1” representing that the distribution is completed, associated with each other, and is stored in the distribution schedule database 55. Meanwhile, the distribution schedule information of a reservation whose distribution schedule ID is “2” includes a user ID which specifies a user indicated by “58,” a content ID which specifies a content indicated by “10,” DL starting scheduled time which is “2006/11/15 16:20” representative of 16:20 of Nov. 15, 2006, DL completion scheduled time which is “2006/11/15 19:30” representative of 19:30 of Nov. 15, 2006, charging information which is “105”, representing that the amount of money to be claimed to the user is 105 yen, a card number of a credit card, a term of validity which is “08/10” representative of August, 2010, and a distribution completion flag which is “0” representing that the distribution is not completed, associated with each other, and is stored in the distribution schedule database 55. Also information whose distribution schedule ID is “3” and so forth is stored in the distribution schedule database 55 similarly. It is so be noted that, while, in FIG. 8, the card number in all reservation information is represented as “****_****_****_****,” actually the entire portion indicated by “*” (asterisk) is given as a number within 16 digits.

In this manner, if a user operates a client terminal apparatus 12 to reserve downloading, then distribution reservation information is generated and stored into the distribution reservation database 53. Further, if the content server 11 carries out a distribution scheduling process, then distribution schedule information is generated based on the distribution schedule information stored in the distribution reservation database 53 and is stored into the distribution schedule database 55. Further, if the distribution of the content is completed, then distribution completion information is generated based on the distribution reservation information stored in the distribution reservation database 53 and stored into the distribution completion database 54.

Referring back to FIG. 3, the advertisement page data 56 are used to allow a client terminal apparatus 12 to display, as a web page, moving pictures or still pictures and characters and so forth which are an advertisement of a content specified by content information stored in the content database 52.

The user authentication page data 57 are used to allow a client terminal apparatus 12 to display, as a web page, a user registration screen image for carrying out registration of a user, a log-in screen image upon user authentication, a user registration changing screen image for user information, a user registration deletion screen image for deleting a registration of a user, and so forth.

The content search/download page data 58 are used to allow a client terminal apparatus 12 to display, as a web page, a content search screen image for search for a content by a user, a download reservation screen image for allowing a user to select one of searched out contents and carry out downloading reservation of the selected content, a download reservation list screen image for indicating a download situation of a content reserved by a user or the like.

The user information registration section 71 decides whether or not user information transmitted thereto from a client terminal apparatus 12 and inputted by a user to a user registration screen image displayed on the client terminal apparatus 12 is already registered in the user authentication database 51. In other words, the user information registration section 71 decides whether or not the user information overlaps. Here, the inputted user information includes a user name, a password and a password reminder. However, the address of a house or a telephone number of the user is inputted arbitrarily as the detailed information.

If the user information overlaps, then the user information registration section 71 instructs the screen display instruction section 72 to display a user registration screen image on the client terminal apparatus 12 in order to urge the user to input a user name or a password different from the overlapping user name or password. On the other hand, if the user information does not overlap, then the user information registration section 71 supplies the user information to the user authentication database 51. In other words, the user information registration section 71 registers the user information into the user authentication database 51. More particularly, the user information registration section 71 registers, for example, the user name, password and password reminder into the user authentication database 51.

Further, the user information registration section 71 reads out the user information of the logged in user from the user authentication database 51 in response to a request to display a user registration changing screen image or a user registration deletion screen image transmitted thereto from the client terminal apparatus 12. Furthermore, the user information registration section 71 instructs the screen display instruction section 72 to display the user information so that the user information may be displayed on a user registration changing screen image or a user registration deletion screen image.

The screen display instruction section 72 instructs the client terminal apparatus 12 to display a screen. More particularly, the screen display instruction section 72 acquires data of a web page to be displayed on the client terminal apparatus 12 from the advertisement page data 56, user authentication page data 57 or content search/download page data 58 of the storage section 38 in response to information indicative of the displaying instruction of a screen from the information registration section 71, viewing reservation settable time calculation section 73, reservation validity decision section 74 or scheduling section 76. Further, the screen display instruction section 72 acquires user information or content information to be displayed on the screen based on the user authentication page data 57 or the content search/download page data 58 from the user authentication database 51 or the content database 52. The screen display instruction section 72 supplies the acquired web page data and user information or content information as screen display information to the communication control section 80 through the bus 34. The client terminal apparatus 12 displays various screen images based on the screen display information supplied thereto from the content server 11.

The viewing reservation settable time calculation section 73 acquires content information of a content selected by the user on a search screen image displayed on the client terminal apparatus 12 from the content database 52 and calculates viewing reservation settable time of the content selected by the user. The viewing reservation settable time indicates the most proximate point of time settable as viewing starting scheduled time of the content selected by the user.

Here, details of calculation of the viewing reservation settable time are described.

It is assumed that a maximum capacity S represents a maximum amount of data which can be distributed in a unit period of time such as, for example, one second by the content server 11, and a content capacity R represents the amount of data of a content reserved for distribution which are to be distributed per unit period of time by the content server 11 while a distribution capacity limit value S1max has a value determined in advance and represents a value for limiting the amount of data to be distributed per unit period of time. Further, it is assumed that a maximum capacity Rc represents a maximum amount of data which can be received per unit period of time by the client terminal apparatus 12, and a content capacity Sc represents the amount of data of a content reserved for distribution per unit period of time to a client terminal apparatus 12.

At this time, the free capacity for distributing a content from the content server 11 to the client terminal apparatus 12 is a smaller one of the “maximum capacity S—content capacity R” and the “content capacity Sc—maximum capacity Rc.” However, since it is desired to avoid to use all of the free capacity by one time of distribution, the lowest value of the “distribution capacity limit value S1max,” “maximum capacity S—content capacity R” and “content capacity Sc—maximum capacity Rc” represented by the expression (1) given below is actually used as the data amount per unit period of time for distribution of the content:

MIN(S−R, Sc−Rc, S1max) (1)

Here, where the data amount of the entire content selected by the user is represented as an entire content capacity C and the period of time requisite to distribute all of the content is represented as distribution time period T, the following expression (2) is satisfied:

$$C = {\int }_{0}^{T} MIN ( S - R , Sc - Rc , S 1 max ) d t \qquad ( 2 )$$

Further, where the time at present is represented as present time Tc and the immediately proximate point of time settable as the viewing starting scheduled time selected by the user is represented by viewing reservation settable time Tr, a relationship indicated by the following expression (3) is satisfied:

Tr≧Tc+T (3)

In particular, the viewing reservation settable time calculation section 73 calculates viewing reservation settable time from the distribution time period and the present point of time. The distribution time period is obtained from the data amount of the entire content selected by the user and the amount of data which can be distributed from the content server 11. The viewing reservation settable time calculation section 73 supplies the calculated viewing reservation settable time and the content information of the content selected by the user to the reservation validity decision section 74.

It is to be noted that actually the maximum capacity which can be distributed by the content server 11 is set to a value lower than the maximum capacity S given hereinabove so as to provide some margin. Accordingly, a relationship given by the following expression (4) is obtained by providing some margin Tm also to the viewing reservation settable time. More particularly, for example, the margin Tm is several hours from one hour to three hours or the like.

Tr≧Tc+T+Tm (4)

The viewing reservation settable time calculation section 73 instructs the screen display instruction section 72 to instruct the client terminal apparatus 12 to display a download reservation screen image on which the content information of the selected content is to be displayed.

The reservation validity decision section 74 decides whether or not a reservation inputted by the user is valid. More particularly, the reservation validity decision section 74 decides, based on information indicative of viewing starting scheduled time inputted by the user on the download reservation screen on which the content information of the selected content is displayed, information representative of whether or not credit settlement of the credit card owned by the user is permissible and information representative of the free capacity of the hard disk or the like of the client terminal apparatus 12, whether or not the reservation of the content is permissible.

At this time, the reservation validity decision section 74 accesses a server of a credit card system through the communication control section 80 and the communication section 39 to inquire about whether or not the credit settlement of the credit card owned by the user is permissible or inquire about the free capacity of the hard disk or the like of the client terminal apparatus 12.

If the reservation is valid, that is, if the reservation of the content is permissible, then the reservation validity decision section 74 acquires the time at which the reservation was made from a time counting section not shown. The reservation validity decision section 74 supplies the content information of the content selected by the user, the information indicative of the reservation time which is the time at which the reservation was made and the viewing starting scheduled time inputted by the user in an associated relationship with each other as distribution reservation information to the distribution reservation information registration section 75. On the other hand, if the reservation is not valid, that is, if the reservation of the content is not permissible, then the reservation validity decision section 74 instructs the screen display instruction section 72 to instruct the client terminal apparatus 12 to display a download reservation screen image on which the content information of the selected content is displayed.

The distribution reservation information registration section 75 registers the distribution reservation information supplied thereto from the reservation validity decision section 74 into the distribution reservation database 53. At this time, the distribution reservation information registration section 75 registers the distribution reservation information into the distribution reservation database 53 such that the user ID which specifies the user of the client terminal apparatus 12 is included in the distribution reservation information.

The scheduling section 76 acquires the distribution reservation information stored in the distribution reservation database 53 and carries out a scheduling process of distribution to the client terminal apparatus 12.

Here, scheduling of distribution is described.

If viewing starting scheduled time Tw represents the viewing starting scheduled time inputted by the user and DL starting scheduled time Ts represents distribution starting time of a content, then a relationship of the following expression (5) is satisfied based on the relationship of the expression (2) given hereinabove:

$$C = {\int }_{Ts}^{Tw - Tm} MIN ( S - R , Sc - Rc , S 1 max ) d t \qquad ( 5 )$$

In particular, the scheduling section 76 calculates DL starting scheduled time Ts which satisfies the expression (5) from the viewing starting scheduled time Tw of the distribution reservation information and a relationship between the data amount of the entire content represented by the expression (2) and the amount of data distributable from the content server 11. Further, the scheduling section 76 calculates the DL starting scheduled time Tw−Tm from the viewing starting scheduled time Tw and the margin Tm. Further, the scheduling section 76 supplies information representative of the calculates DL starting scheduled time Ts and DL starting scheduled time Tw−Tm to the distribution schedule information registration section 77 together with the acquired distribution reservation information.

However, where the load of distribution to the content server 11 is low, that is, where the amount of data to be distributed is comparatively small, the scheduling section 76 carries out scheduling so that downloading of a content represented by the content information of distribution schedule information whose DL starting scheduled time is later than the present point of time and is closest to the present point of time is started at the present point of time. More particularly, the scheduling section 76 checks reservations indicated by distribution schedule information supplied from the distribution schedule information search section 79 hereinafter described and including user IDs associated with those client terminal apparatus 12 which are prepared to start downloading to find out that reservation which indicates the latest time indicated by the viewing starting scheduled time of the distribution reservation information of the distribution reservation database 53 corresponding to the reservation. Then, the scheduling section 76 sets the DL starting scheduled time of the distribution schedule information to the present point of time so that downloading of the reservation is started at the present point of time, and sets the DL ending scheduled time to the sum of the present point of time and the distribution time period.

Alternatively, the scheduling section 76 may check reservations represented by distribution schedule information supplied from the distribution schedule information search section 79 and including user IDS associated with those client terminal apparatus 12 which are prepared to start downloading and calculate the DL starting scheduled time and the DL ending scheduled time so that downloading of that reservation of that client terminal apparatus 12 whose communication speed with the content server 11 is lowest is started at the present point of time.

The scheduling section 76 supplies distribution schedule information including the calculated DL starting scheduled time and DL ending scheduled time to the distribution schedule information registration section 77.

Further, when the scheduling section 76 calculates and supplies the DL starting scheduled time and DL ending scheduled time to the distribution schedule information registration section 77, the scheduling section 76 supplies a scheduling completion notification to the client terminal apparatus 12 representing that the scheduling is completed, which includes information representative of the calculated DL starting scheduled time to the communication control section 80.

The distribution schedule information registration section 77 registers distribution schedule information of a content into the distribution schedule database 55. More particularly, the distribution schedule information registration section 77 generates distribution schedule information based on the distribution reservation information, DL starting scheduled time and DL ending scheduled information supplied thereto from the scheduling section 76 and supplies the distribution schedule information to the distribution schedule database 55.

Further, the distribution schedule information registration section 77 updates the distribution schedule database 55 based on the reservation schedule information supplied from the scheduling section 76 and having the DL starting scheduled time set to the present point of time.

The distribution capacity acquisition section 78 acquires a distribution capacity which is the data amount of a content distributed per unit period of time from the content server 11 at a predetermined point of time. The distribution capacity acquisition section 78 decides based on the acquired distribution capacity of the content whether or not the distribution capacity of the content server 11 has some margin. More particularly, the distribution capacity acquisition section 78 compares the acquired distribution capacity of the content with the distribution capacity limit value S1max to the distribution capacity for one time of distribution described hereinabove to decide whether or not the distribution capacity has some margin. If the distribution capacity has some margin, then the distribution capacity acquisition section 78 supplies information representing that the distribution capacity has some margin to the distribution schedule information search section 79.

The distribution schedule information search section 79 searches for a reservation whose downloading is not started as yet but can be started in response to the information representing that the distribution capacity has some margin. More particularly, the distribution schedule information search section 79 searches for distribution schedule information whose distribution completion flag in the distribution schedule database 55 is “0” and whose DL starting scheduled information is a point of time in the future. The distribution schedule information search section 79 supplies the searched out distribution schedule information to the scheduling section 76.

The communication control section 80 controls the communication section 39 to carry out transmission and reception of data to and from the client terminal apparatus 12. For example, the communication control section 80 controls the communication section 39 to transmit screen display information or receive user information or information representative of the viewing starting scheduled time.

The charging processing section 81 carries out a charging process based on charging information included in the content information of a distributed content and information indicative of the card number and the term of validity of a credit card owned by the user. More particularly, the charging processing section 81 transmits the charging information of the content information of the distributed content and the information representative of the card number and the term of validity of the credit card owned by the user to the server of the credit card system through the communication control section 80 and the communication section 39. The server of the credit card system carries out settlement for the credit card of the user based on the charging information and the information representative of the card number and the term of validity transmitted thereto from the content server 11.

Further, the charging processing section 81 varies the charge in response to the length of the distance in time between the reservation time and the viewing starting scheduled time to carry out the charging process.

The content server 11 utilizes such a configuration as described above to carry out scheduling of distribution of contents.

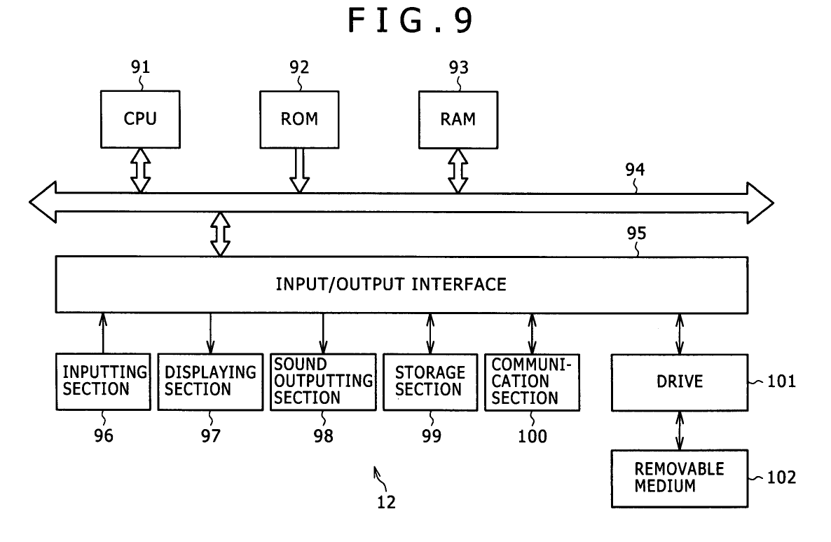

FIG. 9 shows an example of a hardware configuration of a client terminal apparatus 12. Referring to FIG. 9, the client terminal apparatus 12 shown includes a central processing unit (CPU) 91 which executes various processes in accordance with a program recorded in a read-only memory (ROM) 92 or a storage section 99. A program to be executed by the CPU 91, data and so forth are suitably stored into a random access memory (RAM) 93. The CPU 91, ROM 92 and RAM 93 are connected to each other by a bus 94.

An input/output interface 95 is connected to the CPU 91 through the bus 94. An inputting section 96 including a keyboard, a mouse, a microphone and so forth, a display section 97 formed from a display and a sound outputting section 98 formed from a speaker are connected to the input/output interface 95. The CPU 91 executes various processes in response to an instruction inputted from the inputting section 96. The CPU 91 outputs a result of the process to the display section 97 or the sound outputting section 98.

The storage section 99 connected to the input/output interface 95 is formed, for example, from a hard disk drive. The storage section 99 stores programs to be executed by the CPU 91 and various data such as data of contents distributed from the content server 11. A communication section 100 communicates with an external apparatus such as the content server 11 through networks such as the Internet 13 and a local area network.

A program may otherwise be acquired through the communication section 100 and stored into the storage section 99.

A drive 101 is connected to the input/output interface 95 and drives, when a removable medium 102 such as a magnetic disk, an optical disk, a magneto-optical disk or a semiconductor memory is loaded therein, to acquire a program, a data and so forth recorded on the removable medium 102. The acquired program or data is transferred to and recorded into the storage section 99 as occasion demands.

FIG. 10 shows a functional configuration implemented by the CPU 91 of the client terminal apparatus 12 which executes a program.

Referring to FIG. 10, the client terminal apparatus 12 has various functions implemented by execution of a program by the CPU 91. In particular, the client terminal apparatus 12 includes a display control section 111, an inputting control section 112, a transmission control section 113, a reception control section 114 and a power supply control section 115.

The display control section 111 controls the display section 97 to display a screen image based on an instruction to display a screen image from the content server 11. More particularly, the display control section 111 receives screen image displaying information supplied thereto from the content server 11 through the Internet 13, communication section 100 and reception control section 114. The display control section 111 controls the display section 97 to display a user registration screen image, a content search screen image, an image and characters of an advertisement of a content and so forth as a web page based on the received screen image displaying information.

Here, screen images to be displayed on the display section 97 are described with reference to FIGS. 11 to 18.

FIG. 11 shows a user registration screen image used by a user to carry out user registration. Referring to FIG. 11, the user registration screen image includes text boxes disposed thereon for inputting a user name, a password, a password reminder and detailed information through the inputting section 96 in response to an operation of a user. Corresponding to the password, two text boxes are provided for the “password” and the “once again” in order to prevent erroneous inputting of the password by the user. For the password reminder for reminding the user of the password when the user forgets the password, a list box corresponding to the question and a text box corresponding to an answer to the question are provided. The user would select a predetermined question from among the list boxes corresponding to the questions and input an answer to the predetermined question to a text box corresponding to the answer. While, in the example of FIG. 11, the question of the password reminder is “name of pet,” it may otherwise be “name of mother,” “name of completed junior high school” or the like. Meanwhile, an address and a telephone number indicated by TEL which are the detailed information may be inputted arbitrarily.

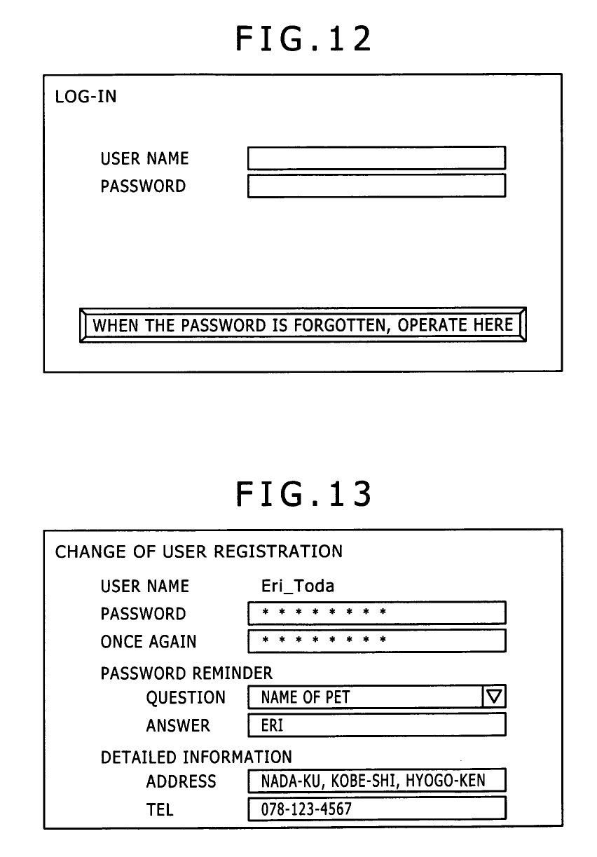

FIG. 12 illustrates a log-in screen image for carrying out authentication of a user who tries to access the content server 11. Referring to FIG. 12, the log-in screen image includes text boxes disposed thereon for inputting a user name and a password. Further, at a lower portion of the log-in screen image, a button which is selected when the user forgets the password is provided. If this button is selected by the user, then a screen image including a question about the password reminder and a text box for inputting an answer of the password reminder is displayed. Further, if the inputted answer of the password reminder is correct, that is, if the user information of the user authentication database 51 of the content server 11 includes the inputted user name and password reminder, then the user registration screen image is displayed so that the password may be set again.

FIG. 13 illustrates a user registration changing screen image for changing user information registered in the content server 11 with regard to a user who has logged in the content server 11 through authentication. Referring to FIG. 13, the user registration changing screen image includes display of a user name of a logged-in user, and a password, a password reminder and detailed information inputted through the user registration screen image by the user. The user can change the information displayed in the text boxes other than the user name.

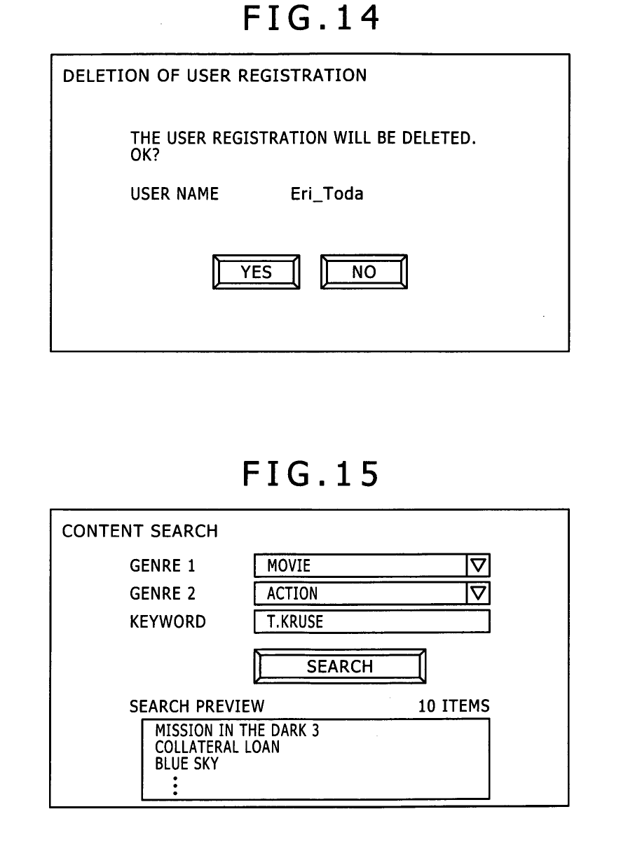

FIG. 14 illustrates a user registration deletion screen image for deleting user information registered with regard to a user logged in the content server 11 through authentication. Referring to FIG. 14, the user registration deletion screen image includes display of a commend of “The user registration will be deleted. OK?,” a user name of a logged in user and buttons for allowing the user to select whether or not the user registration should be deleted. If the user information should be deleted in the content server 11, then the user would select the button indicted by “Yes,” but if the user information should not be deleted, then the user would select the button indicated by “No.”

FIG. 15 illustrates a content search screen image for allowing a user to search for a content. Referring to FIG. 15, the content search screen image includes display of list boxes through which a genre 1 and a genre 2 are selected, respectively, a text box to which a keyword is to be inputted, a search button selected to execute a search, and a search result display area in which a result of the search is to be displayed. In the list box of the genre 1, a genre included in the genre 1 of the content information in the content database 52 is displayed and selected. In the list box of the genre 2, a genre included in the genre 2 of the content information in the content database 52 is displayed and selected. Further, if a character string is inputted to the text box of the keyword, then contents which include the character string serving as a keyword in the content name or the detailed information of the content information in the content database 52 are searched out. In FIG. 15, contents with regard to which the genre 1 is the movie and the genre 2 is the action while the keyword is “T.Kruse” are searched for, and the content names of ten contents including “Mission in the dark 3,” “Collateral loan” and “Blue sky” are displayed as a result of the search. Further, if any of the content names displayed as the result of search is selected by the user, then a download reservation screen image for the selected content is displayed.

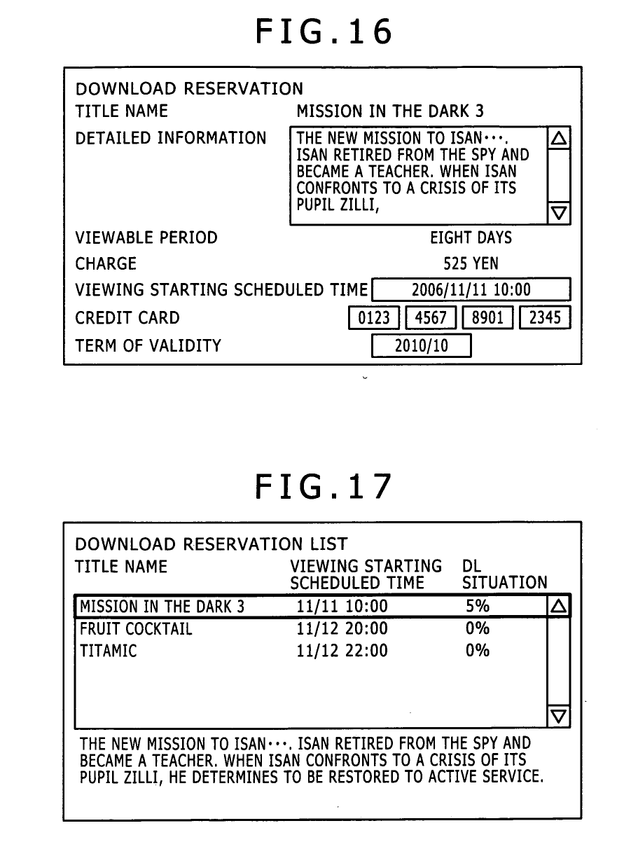

FIG. 16 illustrates a download reservation screen image for allowing a user to carry out reservation for downloading of a content selected based on a search result through the content search screen image. Referring to FIG. 16, the download reservation screen image indicates a title name or content name of a selected content, detailed information, a viewable period and a charge or charging information. Further, the download reservation screen image includes text boxes to which viewing starting scheduled time and the card number and the term of validity of a credit card are to be inputted by the user. The viewable period is determined by the content server 11 and is, for example, eight days from a day indicated by viewing starting scheduled time inputted by the user. Further, on the download reservation screen image, each of the digits representing the card number of a credit card inputted by the user may be indicated by “*.”

FIG. 17 illustrates a download reservation list screen image indicative of a situation of a reservation of downloading carried out by a user. Referring to FIG. 17, the download reservation list screen image includes display of the title name or content name of a content reserved for downloading by an operation of the user, viewing starting scheduled time and a download situation representative of a progressing situation of downloading. Further, in FIG. 17, detailed information of a selected one of displayed contents is displayed at a lower portion of the download reservation list screen image. For example, if one of the contents displayed on the download reservation list screen image is selected by the user, then the download reservation screen image of the distribution reservation information of the selected content is displayed such that the download reservation can be changed by the user.

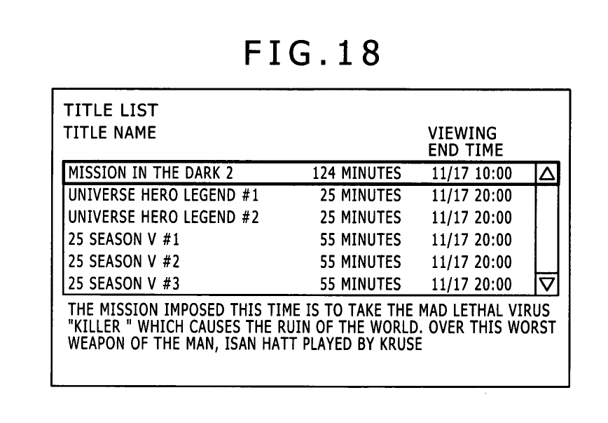

FIG. 18 shows a title list screen image for displaying a table of contents which can be enjoyed by the user because downloading thereof is completed. Referring to FIG. 18, the title list screen image includes display of the title name or content name of contents downloaded and stored in the storage section 99 and the reproduction time period and the viewing ending time of the contents. The reproduction time period of a content is calculated, for example, based on the capacity of the content information in the content database 52. Meanwhile, the viewing ending time is a term of viewing and is calculated from the reproduction time period and the viewable period of the content. The content whose term of viewing has expired is deleted by the client terminal apparatus 12.

Referring back to FIG. 10, the inputting control section 112 controls the inputting section 96 to acquire a signal representative of an instruction of a user from the inputting section 96 issued in response to an operation of the user. For example, the inputting control section 112 acquires a signal representative of user information of the user inputted from the keyboard of the inputting section 98 in response to an operation of the user from the inputting section 98 and supplies the signal to the transmission control section 113.

The transmission control section 113 controls transmission of the communication section 100. For example, the transmission control section 113 supplies information inputted from the keyboard and supplied from the inputting control section 112 to the communication section 100. The transmission control section 113 controls the communication section 100 to transmit information inputted from the keyboard.

The reception control section 114 controls reception of the communication section 100. For example, the reception control section 114 supplies screen display information for displaying various screen images received by the communication section 100 to the display control section 111. Further, for example, the reception control section 114 controls the communication section 100 to receive a scheduling completion notification supplied from the content server 11 and representing that scheduling is carried out including information representing download starting scheduled time. Then, the reception control section 114 supplies the received scheduling completion notification to the power supply control section 115. The reception control section 114 controls the communication section 100 to receive a content reserved for downloading and distributed from the content server 11, and supplies the received content to the storage section 99.

The power supply control section 115 controls the power supply based on a notification supplied thereto from the reception control section 114 and including information representative of download starting scheduled time to turn on the power to the client terminal apparatus 12.

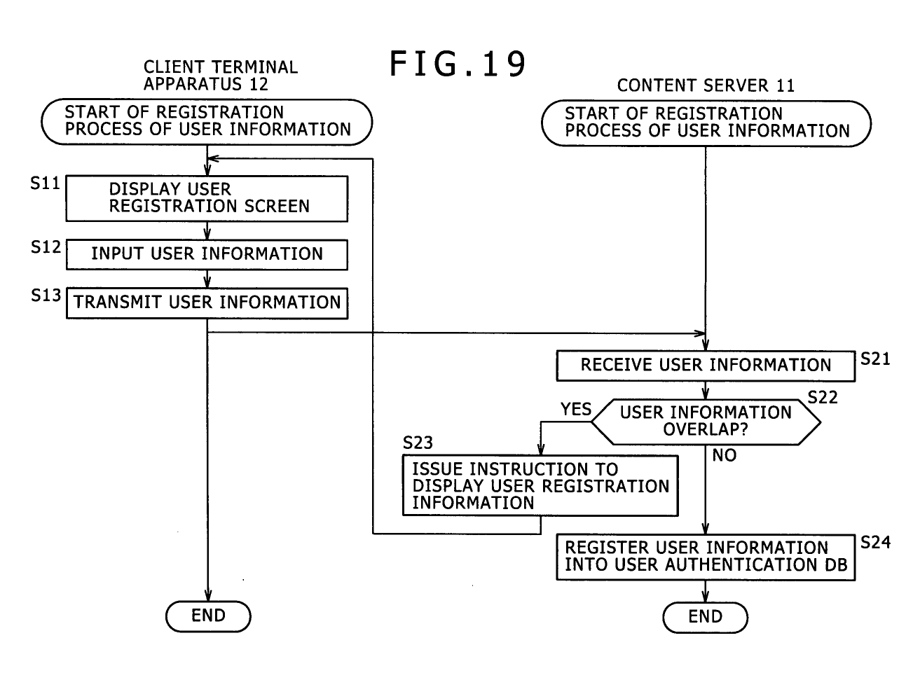

Now, a process of registering user information executed by the content server 11 and a client terminal apparatus 12 in the content distribution system 1 of FIG. 1 is described with reference to a flow chart of FIG. 19.

The user information registration process is started, for example, when the client terminal apparatus 12 in the content distribution system 1 transmits a request to display a user registration screen image for carrying out registration of a user inputted by an operation of the inputting section 98 to the content server 11 through the communication section 100 and then receives, as a reply to the request, screen display information representative of a displaying instruction of the user registration screen from the content server 11.

At step S11, the display section 97 of the client terminal apparatus 12 displays the user registration screen. More particularly, the reception control section 114 supplies screen display information representative of a displaying instruction of the user registration screen image received by the communication section 100 to the display control section 111. The display control section 111 controls the display section 97 to display the user registration screen based on the screen display information supplied thereto.

At step S12, the inputting section 96 of the client terminal apparatus 12 inputs user information. More particularly, the inputting control section 112 acquires a signal representative of user information inputted by an operation of the user through the user registration screen image and supplies the user information to the transmission control section 113.

At step S13, the communication section 100 of the client terminal apparatus 12 transmits the user information. More particularly, the transmission control section 113 supplies the user information supplied thereto from the inputting control section 112 and supplies the user information to the communication section 100. The transmission control section 113 controls the communication section 100 to transmit the user information.

At step S21, the communication section 39 of the content server 11 receives the user information. More particularly, the communication control section 80 controls the communication section 39 to receive the user information transmitted thereto from the client terminal apparatus 12. The communication control section 80 supplies the user information received by the communication section 39 to the user information registration section 71.

At step S22, the user information registration section 71 of the content server 11 decides whether or not the user information overlaps. More particularly, the user information registration section 71 decides whether or not the user information supplied thereto is registered already in the user authentication database 51. If it is decided that the user information overlaps, then the user information registration section 71 controls the screen display instruction section 72 to issue an instruction to display the user registration screen image to the client terminal apparatus 12. Thereafter, the processing advances to step S23.

At step S23, the screen display instruction section 72 issues an instruction to display the user registration screen image to the client terminal apparatus 12. In particular, the screen display instruction section 72 acquires data of the user registration screen image from the storage section 38 in response to the information indicative of the instruction to display the user registration screen image from the user information registration section 71. The screen display instruction section 72 supplies the acquired data of the user registration screen image as screen display information to the communication control section 80 through the bus 34. The communication control section 80 controls the communication section 39 to transmit the screen display information. The client terminal apparatus 12 receives the screen display information and repeats the processes at the steps beginning with step S11. In particular, the client terminal apparatus 12 urges the user to input user information again.

On the other hand, if it is decided at step S23 that the user information does not overlap, then the processing advances to step S24.

At step S24, the user information registration section 71 registers the user information into the user authentication database 51 and ends the processing.

The user information inputted to the client terminal apparatus 12 is registered into the content server 11 in this manner.

Now, a process of reserving downloading of a content executed by the content server 11 and the client terminal apparatus 12 in the content distribution system 1 of FIG. 1 is described with reference to a flow chart of FIG. 20.

The content downloading reservation process in the content distribution system 1 is started, for example, when the client terminal apparatus 12 transmits a request to display the content search screen image inputted by an operation of the inputting section 96 to the content server 11 through the communication section 100 and then receives, as a reply to the request, screen display information representative of an instruction to display the content search screen image from the content server 11.

At step S31, the display section 97 of the client terminal apparatus 12 displays the content search screen image. More particularly, the reception control section 114 supplies the screen display information representative of the instruction to display the content search screen received by the communication section 100 to the display control section 111. The display control section 111 controls the display section 97 to display the content search screen based on the screen display information supplied thereto.

At step S32, the inputting control section 112 decides whether or not a searching instruction is inputted. More particularly, the inputting control section 112 decides a signal inputted by an operation of the user through the content search screen and representative of an instruction to search for contents based on the genre 1 and the genre 2 or the keyword.

If it is decided at step S32 that a searching instruction is not inputted, then the process at step S32 is repeated until after a searching instruction is inputted.

On the other hand, if it is decided at step S32 that a searching instruction is inputted, then the inputting control section 112 supplies information for searching for contents, that is, information representative of data of the genre 1 and the genre 2 or the keyword, to the transmission control section 113. The transmission control section 113 supplies the information for searching for contents supplied thereto to the communication section 100 so that the information is transmitted from the client terminal apparatus 12 to the content server 11.

At step S33, the reception control section 114 decides whether or not the user logs in. More particularly, the reception control section 114 decides whether or the user logs in depending upon the fact that content information transmitted from the content server 11 as a result of a search for contents is received or the fact that screen display information representative of an instruction to display a log-in screen image is received together with information that a log-in history of the user of the client terminal apparatus 12 is not found.

If it is decided at step S33 that the user does not log in, that is, if the screen display information representative of an instruction to display the log-in screen image is received by the communication section 100 together with information that a log-in history of the user of the client terminal apparatus 12 is not found, then the processing advances to step S34.

At step S34, the display section 97 displays the log-in screen image. More particularly, the reception control section 114 supplies the screen display information representative of the instruction to display the log-in screen image received by the communication section 100 together with the information that a log-in history of the user is not found to the display control section 111. The display control section 111 controls the display section 97 to display the log-in screen image based on the screen display information representative of the instruction to display the log-in screen image.

Here, if the signal representative of the user information for log-in is supplied from the inputting section 98, then the inputting control section 112 supplies the user information to the transmission control section 113. The transmission control section 113 supplies the user information supplied thereto to the communication section 100 so as to be transmitted to the content server 11. Further, if the content server 11 carries out user authentication based on the user information transmitted thereto from the client terminal apparatus 12, then the communication section 100 receives content information as a result of the search for contents from the content server 11. The reception control section 114 supplies the content information received by the communication section 100 to the display control section 111. The display control section 111 controls the display section 97 to display the content name from within the content information supplied from the reception control section 114 in the search result display region together with the content search screen image displayed at step S31. After the process at step S34, the processing advances to step S35.

On the other hand, if it is decided at step S33 that the user logs in, that is, if the communication section 100 receives content information as a result of the search for contents, then the reception control section 114 supplies the content information received by the communication section 100 to the display control section 111. The display control section 111 controls the display section 97 to display the content name from within the content information supplied from the reception control section 114 within the search result display region together with the content search screen image displayed at step S31. Thereafter, the processing advances to step S35.

At step S35, the inputting section 96 selects a content. In particular, the inputting control section 112 acquires a signal representing that the content name of a predetermined content from within the search result displayed on the content search screen image from the inputting section 96, and supplies the signal to the transmission control section 113. The transmission control section 113 controls the communication section 100 to transmit the content information of the selected content.

At step S51, the viewing reservation settable time calculation section 73 of the content server 11 calculates viewing reservation settable time of the content selected by the user on the content search screen. In particular, the viewing reservation settable time calculation section 73 calculates the viewing reservation settable time from distribution time obtained from the capacity or data amount of the content selected by the user and the distribution capacity for distribution from the content server 11 based on the content information transmitted from the client terminal apparatus 12 and also from the present point of time. Then, the viewing reservation settable time calculation section 73 supplies information representative of the viewing reservation settable time and the content information to the reservation validity decision section 74. The viewing reservation settable time calculation section 73 controls the screen display instruction section 72 to instruct the client terminal apparatus 12 to display the download reservation screen image on which the content information of the selected content is displayed.

At step S52, the screen display instruction section 72 issues an instruction to display the download reservation screen image. More particularly, the screen display instruction section 72 acquires data of the download reservation screen image from the storage section 38 in response to the information representative of the instruction to display the download reservation screen image from the viewing reservation settable time calculation section 73. Further, the screen display instruction section 72 acquires the content information of the content to be displayed on the download reservation screen image from the content database 52. The screen display instruction section 72 supplies the acquired data of the download reservation screen image and the acquired content information as screen display information to the communication control section 80 through the bus 34. The communication control section 80 controls the communication section 39 to transmit the screen display information.

At step S36, the display section 97 of the client terminal apparatus 12 displays the download reservation screen image. More particularly, the display control section 111 controls the display section 97 to display the download reservation screen image based on the screen display information supplied thereto from the content server 11.

At step S37, the inputting section 96 inputs viewing starting scheduled time. More particularly, the inputting control section 112 acquires a signal of the viewing starting scheduled time and the card number and the term of validity of a credit card inputted from the inputting section 96 by an operation of the user. Then, the inputting control section 112 supplies information representative of the viewing starting scheduled time and card number and term of validity of the credit card to the transmission control section 113.

At step S38, the communication section 100 transmits the inputted viewing starting scheduled time to the content server 11. More particularly, the transmission control section 113 supplies the information representative of the viewing starting scheduled time and card number and term of validity of the credit card supplied thereto from the inputting control section 112 to the communication section 100. The transmission control section 113 controls the communication section 100 to transmit the information representative of the viewing starting scheduled time and card number and term of validity of the credit card.

At step S53, the reservation validity decision section 74 of the content server 11 decides whether or not the reservation inputted by the user is valid. In particular, the reservation validity decision section 74 decides, based on the information transmitted from the client terminal apparatus 12 and representative of the viewing starting scheduled time and card number and term of validity of the credit card, whether or not reservation of the content is permissible.

More particularly, the reservation validity decision section 74 compares the information representative of the viewing reservation settable time supplied from the viewing reservation settable time calculation section 73 with the information transmitted from the client terminal apparatus 12 and representative of the reservation starting scheduled time to decide whether or not the viewing starting scheduled time is later, that is, in the future with respect to, the viewing reservation settable time. Further, for example, the reservation validity decision section 74 accesses, based on the information transmitted from the client terminal apparatus 12 and representative of the card number and the term of validity, the server of the credit card system through the communication control section 80 and the communication section 39 to inquire about whether or not the credit settlement of the credit card owned by the user is permissible. Furthermore, for example, the reservation validity decision section 74 issues an inquiry about the free capacity of a hard disk and so forth of the client terminal apparatus 12 through the communication control section 80 and the communication section 39.

If it is decided at step S53 that the reservation is valid, that is, if the viewing starting scheduled time is later than the viewing reservation settable time and the credit card owned by the user is valid and besides the free capacity of the hard disk and so forth of the client terminal apparatus 12 is sufficient, then the reservation validity decision section 74 acquires time at which the reservation was made from the time counting section not shown. The reservation validity decision section 74 supplies the content information of the content selected by the user, the information representative of the reservation time which is the time at which the reservation was made and the information representative of the viewing reservation scheduled time inputted by the user as distribution reservation information to the distribution reservation information registration section 75. Thereafter, the processing advances to step S54.

If it is decided at step S53 that the reservation is not valid, that is, if the viewing starting scheduled time is earlier than the viewing reservation settable time or the credit card owned by the user is not valid or else the free capacity of the hard disk and so forth of the client terminal apparatus 12 is not sufficient, then the processing returns to step S52. At step S52, the reservation validity decision section 74 causes the screen display instruction section 72 to issue an instruction to display the download reservation screen image of the selected content to the client terminal apparatus 12. In other words, the content server 11 urges the user to carry out an inputting operation to the download reservation screen image again.

At step S54, the distribution reservation information registration section 75 registers the distribution reservation information supplied thereto from the reservation validity decision section 74 into the distribution reservation database 53. At this time, the distribution reservation information registration section 75 registers the distribution reservation information so as to include the user ID for the specification of the user of the client terminal apparatus 12 into the distribution reservation database 53.

At step S55, the scheduling section 76 acquires the distribution reservation information stored in the distribution reservation database 53 and carries out scheduling of distribution to the client terminal apparatus 12. More particularly, the scheduling section 76 calculates the download starting scheduled time Ts and the download ending scheduled time Tw−Tm which satisfy the expression (5) from the viewing starting scheduled time Tw of the distribution reservation information and the relationship between the data amount of the entire content represented by the expression (2) and the amount of data distributable from the content server 11. Further, the scheduling section 76 supplies information representative of the download starting scheduled time Ts and the download ending scheduled time Tw−Tm calculated as described above to the distribution schedule information registration section 77 together with the acquired distribution reservation information. The distribution schedule information registration section 77 supplies the distribution schedule information to the distribution schedule database 55 based on the distribution reservation information, download starting scheduled time and download ending scheduled time supplied thereto from the scheduling section 76.

At step S56, the communication section 39 transmits a scheduling completion notification to the client terminal apparatus 12 and ends the content download reservation process of the content server 11. More particularly, the scheduling section 76 supplies the scheduling completion notification including information representative of the calculated download starting scheduled time to the communication control section 80. The communication control section 80 transmits the scheduling completion notification to the communication section 39. Further, the screen display instruction section 72 issues, in response to the scheduling carried out by the scheduling section 76, an instruction to display the content search screen image to the client terminal apparatus 12. In other words, the communication control section 80 controls the communication section 39 to transmit the screen display information representative of the instruction to display the content search screen.

At step S39, the display section 97 of the client terminal apparatus 12 displays the content search screen, and the content download reservation process of the client terminal apparatus 12 ends therewith. More particularly, the reception control section 114 controls the communication section 100 to receive the screen display information supplied from the content server 11 and representative of the instruction to display the content search screen image, and supplies the screen display information to the display control section 111. The display control section 111 controls the display section 97 to display the content search screen image based on the screen display information supplied thereto.

Further, at this time, the reception control section 114 controls the communication section 100 to receive the scheduling completion notification supplied from the content server 11 and supplies the notification to the power supply control section 115. The power supply control section 115 sets, based on the information representative of the download starting scheduled time included in the scheduling completion notification supplied from the reception control section 114, for example, a timer to control the power supply so that the power to the client terminal apparatus 12 may be switched on by the download starting scheduled time. Consequently, the client terminal apparatus 12 is placed into a state wherein it can receive a content at the download starting scheduled time, and can start downloading.

Further, when the distribution of the content, that is, the downloading of the client terminal apparatus 12, is completed, the content server 11 updates the distribution reservation database 53, distribution completion database 54 and distribution schedule database 55. More particularly, the distribution reservation information registration section 75 updates the distribution completion flag of the distribution reservation information of the distribution reservation database 53 whose distribution is completed from “0” to “1.” Further, the distribution schedule information search section 79 updates the distribution completion flag for the distribution schedule information from “0” to “1.” Furthermore, the distribution reservation information registration section 75 extracts the distribution reservation information of the updated distribution reservation database 53 and registers the extracted distribution reservation information into the distribution completion database 54.

Further, when the content distribution is completed, the content server 11 carries out a charging process for the user who made the reservation. More particularly, the charging processing section 81 transmits charging information for the content information of the distributed content and information representative of the card number and the term of validity of the credit card owned by the user to the server of the credit card system through the communication control section 80 and the communication section 39. The server of the credit system carries out settlement for the credit card of the user based on the charging information and the information representative of the card number and the term of validity transmitted from the content server 11.

Further, the charge in the charging process described above may be varied in response to the length of the distance in time between the reservation time and the viewing starting scheduled time. For example, where the viewing starting scheduled time is later by more than one week than the reservation time, a charging processing section not shown may discount the amount of money indicated by the charging information for the content information by 20% to determine an amount of money to be settled in the charging process for the content.

In this manner, in the content distribution system 1, the content server 11 can carry out scheduling of distribution of a content so that the content may be downloaded by the viewing starting scheduled time supplied from the client terminal apparatus 12.

While, in the content distribution system 1, distribution scheduling is carried out in accordance with the viewing starting scheduled time as described above, for example, where the load of distribution to the content server 11 is low, if some distribution schedule information does not reach its download starting scheduled time, then re-scheduling may be carried out so that downloading may be started beginning with any reservation whose distribution is possible.

FIG. 21 illustrates a re-scheduling process of the content server 11. The re-scheduling process is executed periodically after every predetermined interval of time such as after every 30 minutes.

Referring to FIG. 21, at step S71, the distribution capacity acquisition section 78 decides whether or not the distribution capacity at the present point of time has some margin. In particular, the distribution capacity acquisition section 78 decides whether or not the distribution capacity of a content distributed from the content server 11, which is acquired at a predetermined point of time, has some margin. If it is decided that the distribution capacity has some margin, then the distribution capacity acquisition section 78 supplies information representing that the distribution capacity has some margin to the distribution schedule information search section 79. Thereafter, the processing advances to step S72.

At step S72, the distribution schedule information search section 79 searches for those reservations whose downloading is not started as yet and besides can be started in response to the information indicating that the distribution capacity has some margin. More particularly, the distribution schedule information search section 79 searches the distribution schedule database 55 for those reservations whose download starting scheduled time is future time and with regard to which communication with a client terminal apparatus 12 of the distribution destination of the content is possible.

At step S73, the distribution schedule information search section 79 decides whether or not downloading is not started as yet with some reservation. More particularly, the distribution schedule information search section 79 decides whether or not a search result of the distribution schedule database 55 includes some reservation whose download starting scheduled time is future time. If it is decided that downloading is not started with some reservation, then the distribution schedule information search section 79 supplies the distribution schedule information of the search result to the scheduling section 76. Then, the processing advances to step S74.

At step S74, the communication control section 80 decides whether or not the client terminal apparatus 12 is ready for starting of downloading. More particularly, for example, the communication control section 80 controls the communication section 39 to transmit a predetermined command for confirming a communication state to a client terminal apparatus 12 stored in an associated relationship with the user ID included in the distribution schedule information searched out by the distribution schedule information search section 79, for example, through an IP (Internet Protocol) address in the RAM 33 or the like. If the communication section 39 receives a response from the client terminal apparatus 12 to the command transmitted as described above, then the communication control section 80 decides that the client terminal apparatus 12 is in a state ready for starting of downloading. Then, the processing advances to step S75.

At step S75, if the load of distribution to the content server 11 is low, that is, if the distribution data amount has some margin, then the scheduling section 76 carries out scheduling so that downloading of that content which is represented by the content information whose download starting scheduled time is later than the present point of time and whose distribution schedule information is nearest to the present point of time may be started at the present point of time. More particularly, for example, the scheduling section 76 detects, from among reservations indicated by distribution schedule information which is supplied from the distribution schedule information search section 79 and includes a user ID associated with any of those client terminal apparatus 12 which are ready for starting of downloading, that reservation which has the earliest time indicated by the viewing starting scheduled time of the distribution reservation information of the distribution reservation database 53 corresponding to the reservation. Then, the scheduling section 76 sets the download starting scheduled time of the distribution schedule information to the present point of time so that downloading of the detected reservation may be started at the present point of time. Further, the scheduling section 76 sets the download ending scheduled time to the sum of the present point of time and the distribution time period. The scheduling section 76 supplies the distribution schedule information whose download starting scheduled time calculated as described above is set to the present point of time to the distribution schedule information registration section 77.

At step S76, the distribution schedule information registration section 77 updates the distribution schedule database 55 based on the distribution schedule information supplied thereto from the scheduling section 76 and having the download starting scheduled time set to the present point of time. Then, the re-scheduling process is ended. Thereafter, the content server 11 starts distribution of the content to the client terminal apparatus 12 associated with the user ID of the distribution schedule information whose download starting scheduled time is set to the present point of time.

On the other hand, if it is decided at step S71 that the distribution capacity then does not have any margin or if it is decided at step S72 that downloading is started with all reservations or else if it is decided at step S73 that the client terminal apparatus 12 is not ready for starting of downloading, then re-scheduling may not be carried out, and therefore, the processing is ended.

In this manner, the content server 11 can carry out scheduling of distribution in response to the current distribution capacity or the state of the client terminal apparatus 12.

Further, also while the user is enjoying the content downloaded in such a manner as described above, the client terminal apparatus 12 can download another content.

It is to be noted that, while, in the description above, a content is searched for based on genres and a keyword inputted through a client terminal apparatus 12, the client terminal apparatus 12 may otherwise store liking information values representative of likings of the user regarding contents such that a content may be searched for and downloaded in accordance with the liking values. In this instance, the charging process for the user is carried out when the user enjoys the downloaded content.

According to the present embodiment described hereinabove, if a user sets time at which the user wants to enjoy a content and carries out reservation for downloading of the content, then the user can enjoy the content agreeably when the user wants to enjoy even if the content is of high picture quality.

Further, in the present embodiment, since the content is distributed efficiently by the time at which the user wants to enjoy the content, the load to the server can be reduced. Further, even if a user carries out reservation at time later than a different user, if the viewing starting scheduled time of the reservation of the user is earlier than the reservation of the different user, then the user can enjoy the content earlier than the different user.

As described above, if a request for transmission of a content is issued, then the content can be distributed. Further, an information processing apparatus controls inputting of viewing starting scheduled time at which the user is to start enjoyment of a content whose transmission is requested and controls transmission of information indicative of the inputted viewing starting scheduled time to an information distribution apparatus. The information distribution apparatus registers distribution reservation information within which information indicative of viewing starting scheduled time transmitted thereto from a plurality of information processing apparatus and content information representative of contents whose reception is requested individually from the information processing apparatus are associated with each other. Then, the information distribution apparatus calculates, based on the distribution reservation information, for each of the information processing apparatus, distribution starting scheduled time at which distribution of a content is to be started and which is earlier than the viewing starting scheduled time of the content and distribution ending scheduled time at which the distribution of the content is to be ended to carry out scheduling of distribution of the contents. In this instance, each content can be distributed efficiently by the time at which the user wants to enjoy the content.

Further, where the communication with the information distribution apparatus is controlled, the information processing apparatus can issue a request for transmission of a content. Further, where inputting of viewing starting scheduled time at which enjoyment of a content whose transmission is requested is to be started is controlled and transmission of information indicative of the inputted viewing starting scheduled time to the information distribution apparatus is controlled, the information processing apparatus can issue a request so that it can efficiently receive a content by time at which the user wants to enjoy the content.

Further, where communication of the information distribution apparatus with an information processing apparatus is controlled, the information distribution apparatus can distribute a content. Further, the information processing apparatus registers distribution reservation information within which information indicative of viewing starting scheduled time transmitted thereto from a plurality of information processing apparatus and representative of time at which users are to start enjoyment of contents whose transmission is requested from the information processing apparatus and content information representative of contents whose transmission is requested individually from the information processing apparatus are associated with each other. Then, the information distribution apparatus calculates, based on the distribution reservation information, for each of the information processing apparatus, distribution starting scheduled time at which distribution of a content is to be started and which is earlier than the viewing starting scheduled time of the content and distribution ending scheduled time at which the distribution of the content is to be ended to carry out scheduling of distribution of the contents. In this instance, each content can be distributed efficiently by the time at which the user wants to enjoy the content.

While, in the foregoing description, the present invention is applied to a system formed from a content server and client terminal apparatus, the present invention can be applied to any information distribution system which includes an information distribution apparatus which distributes a content and an information processing apparatus which issues a request for a content.

The serried of processes describe previously can be carried out by hardware and/or execution of software. If the series of processes described above is carried out by execution of software, programs composing the software can be installed into the CPU 31 from the removable media 48.

It is to be noted that, in the present specification, the steps which describe the program recorded in or on the removable medium 48 may be but need not necessarily be processed in a time series in the order as described, and include processes which are executed parallelly or individually without being processed in a time series.

While a preferred embodiment of the present invention has been described using specific terms, such description is for illustrative purpose only, and it is to be understood that changes and variations may be made without departing from the spirit or scope of the following claims.

What is claimed is:

1. An information processing system, comprising:
a plurality of information processing apparatus configured to issue a request for transmission of a content; and
an information distribution apparatus configured to distribute the content to said information processing apparatus;
each of said information processing apparatus including
an inputting control section configured to control inputting of viewing starting scheduled time at which a user is to start enjoyment of the content whose transmission is requested, and
a transmission control section configured to control transmission of information indicative of the inputted viewing starting scheduled time to said information distribution apparatus;
said information distribution apparatus including
a distribution reservation information registration section configured to register distribution reservation information within which information indicative of viewing starting scheduled time transmitted from the plural information processing apparatus and content information representative of contents whose transmission is requested individually from the plural information processing apparatus are associated with each other, and
a scheduling section configured to calculate, based on the distribution reservation information, for each of the information processing apparatus, distribution starting scheduled time which is earlier than the viewing starting scheduled time and at which distribution of a content is to be started and distribution ending scheduled time at which the distribution of the content is to be ended thereby to carry out scheduling of distribution of the contents.

2. An information processing apparatus which issues a request for transmission of a content to an information distribution apparatus, comprising:
an inputting control section configured to control inputting of viewing starting scheduled time at which a user is to start enjoyment of the content whose transmission is requested; and
a transmission control section configured to control transmission of information indicative of the inputted viewing starting scheduled time to the information distribution apparatus.

3. The information processing apparatus according to claim 2, further comprising:
a reception control section configured to control reception of a scheduling completion notification transmitted from the information distribution apparatus and indicating that distribution of the content is scheduled as a result of calculation of distribution starting scheduled time which is earlier than the viewing starting scheduled time and at which distribution of the content is to be started and distribution ending scheduled time at which the distribution of the content is to be ended; and
a power supply control section configured to control the power supply based on the distribution starting scheduled time included in the scheduling completion notification so that the power supply is turned on by the distribution starting scheduled time.

4. The information processing apparatus according to claim 3, wherein said reception control section controls reception of the content whose transmission is requested and whose distribution is scheduled by the information distribution apparatus.

5. An information processing method for an information processing apparatus which issues a request for transmission of a content to an information distribution apparatus, comprising the steps of:
controlling inputting of viewing starting scheduled time at which a user is to start enjoyment of the content whose transmission is requested; and
controlling transmission of information indicative of the inputted viewing starting scheduled time to the information distribution apparatus.

6. An information distribution apparatus which distributes a content to an information processing apparatus, comprising:
a distribution reservation information registration section configured to register distribution reservation information wherein information transmitted from a plurality of information processing apparatus and indicative of viewing starting scheduled time at which a user of each of the information processing apparatus is to start enjoyment of a content whose transmission is requested from the information processing apparatus and content information transmitted from each of the plural information processing apparatus and indicative of the content whose transmission is requested from the information processing apparatus are associated with each other; and
a scheduling section configured to calculate, based on the distribution reservation information, for each of the information processing apparatus, distribution starting scheduled time which is earlier than the viewing starting scheduled time and at which distribution of a content is to be started and distribution ending scheduled time at which the distribution of the content is to be ended thereby to carry out scheduling of distribution of the contents.

7. The information distribution apparatus according to claim 6, wherein said distribution reservation information registration section registers the distribution reservation information wherein information indicative of viewing starting scheduled time transmitted from the plural information processing apparatus and information indicative of the amount of data of the contents whose transmission is requested individually from the plural information processing apparatus; and
said scheduling section calculates, for each of the information processing apparatus, the distribution starting scheduled time and the distribution ending scheduled time from the viewing starting scheduled time, the data amount of the content, and a distribution capacity representative of the amount of data which can be distributed to the information processing apparatus thereby to carry out the scheduling of distribution of the contents.

8. The information distribution apparatus according to claim 6, further comprising:
a viewing reservation settable time calculation section configured to calculate, for each of the information processing apparatus, from the present point of time and a distribution time period requisite to distribute the content whose transmission is requested by the user and obtained from the amount of data of the content and a distribution capacity representative of the amount of data which can be distributed to the information processing apparatus, viewing scheduled settable time which is time which is most proximate to the viewing starting scheduled time of the content whose transmission is requested by the user and which is settable as the viewing starting scheduled time; and
a validity decision section configured to compare the viewing reservation settable time and the viewing starting scheduled time with each other to decide whether or not the request for transmission of the content from the information processing apparatus is valid.

9. The information distribution apparatus according to claim 8, wherein said validity decision section decides whether or not the request for transmission of the content is valid based on information representative of whether credit settlement of a credit card owned by the user is permissible or information representative of a free capacity of a recording medium of the information processing apparatus.

10. The information distribution apparatus according to claim 6, further comprising:
a distribution schedule information registration section configured to register distribution schedule information within which the content information of the contents whose transmission is requested by the users and the distribution starting scheduled time and the distribution ending scheduled time are associated with each other;
said scheduling section carrying out the scheduling such that, where the amount of data to be distributed to the information processing apparatus has some margin, distribution of that one of the contents with regard to which the distribution starting scheduled time of the distribution schedule information is later than the present point of time but is nearest to the present point of time is started at the present point of time of the content, represented by the content information, in the distribution schedule information.

11. The information distribution apparatus according to claim 6, wherein the content information includes charging information representative of an amount of money to be claimed to the user in response to distribution of the content and information indicative of a card number representative of the number of a credit card owned by the user and a term of validity of the credit card and used to carry out credit settlement of the amount of money indicated by the charging information;
said information distribution apparatus further comprising a charging processing section configured to carry out a charging process based on the charging information and the information indicative of the card number representative of the number of the credit card and the term of validity of the credit card.

12. The information distribution apparatus according to claim 11, wherein said charging processing section changes the amount of money in response to the length of an interval of time between reservation time at which the information representative of the viewing starting scheduled time is transmitted from the information processing apparatus and the viewing starting scheduled time to carry out the charging process.

13. An information distribution method for an information distribution apparatus which distributes a content to an information processing apparatus, comprising the steps of:
registering distribution reservation information wherein information transmitted from a plurality of information processing apparatus and indicative of viewing starting scheduled time at which a user of each of the information processing apparatus is to start enjoyment of a content whose transmission is requested from the information processing apparatus and content information transmitted from each of the plural information processing apparatus and indicative of the content whose transmission is requested from the information processing apparatus are associated with each other; and
calculating, based on the distribution reservation information, for each of the information processing apparatus, distribution starting scheduled time which is earlier than the viewing starting scheduled time and at which distribution of a content is to be started and distribution ending scheduled time at which the distribution of the content is to be ended thereby to carry out scheduling of distribution of the contents.
